(19) United States
(12) Patent Application Publication
(10) Pub. No.: US 2025/0151943 A1
(43) Pub. Date: May 15, 2025

(54) CONTAINER AND FRENCH PRESS AND METHODS ASSOCIATED THEREWITH

(71) Applicant: YETI Coolers, LLC, Austin, TX (US)

(72) Inventors: Dustin R. Bullock, Austin, TX (US); Daniel R. DiDomenico, Austin, TX (US); Luke Schaffner, Austin, TX (US)

(73) Assignee: YETI Coolers, LLC, Austin, TX (US)

(21) Appl. No.: 18/389,025

(22) Filed: Nov. 13, 2023

(51) Int. Cl. A47J 31/20; A47J 31/44

(52) U.S. Cl. CPC A47J 31/20; A47J 31/4407

(57) ABSTRACT

An insulated container assembly and French press assembly can be configured to retain beverages. The French press assembly may be secured to a container for mixing and pouring beverages. The French press assembly may include a lid assembly and the base assembly connected by a connect rod. The lid assembly may include a handle and a lid with the handle connected to a first end of the connect rod and the lid slidably connected to the connect rod. The base assembly may be connected to a second end of the connect rod. The base assembly may include a plunger with a valve and a wiper gasket. The valve may be located on a top side of the plunger and the wiper gasket may be located around a periphery of the plunger.

### FIELD

The present disclosure herein relates broadly to containers, and more specifically to rigid insulated containers and French press assemblies used for beverages.

### BACKGROUND

A container may be configured to store a volume of liquid. Containers may be composed of rigid materials, such as a metal. These containers can be formed of a double-wall vacuum-formed construction to provide insulative properties to help maintain the temperature of the food or beverage within the container. The container may include a French press assembly used as a manual coffee/beverage maker with a container, a plunger, and a filter that percolates the coffee and/or beverage. The French press may utilize just-boiled water to steep course grinds for a set period of time. The French press assembly uses pressure to force coffee/beverage grinds to the bottom of a container after brewing, thereby capturing the concentrated flavors of the coffee/beverage.

### BRIEF SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

In certain examples, an insulated container assembly can be configured to retain beverages. The insulated container assembly can include an insulated container and a French press assembly. The French press assembly may be secured to a container for mixing and pouring beverages.

The French press assembly may include a lid assembly and a base assembly. The lid assembly may be configured to mate with a top portion of a container. The lid assembly may comprise: a lid slidably connected to a connect rod and a handle connected to a first end of the connect rod. The lid may include a vent portion extending around a hole on a radial center of the lid. The vent portion may prevent glugging when pouring a beverage from the container. The base assembly may be connected to the lid assembly with the connect rod. The base assembly may comprise: a plunger, a valve symmetrically engaged with a top portion of the plunger, and a gasket located around a periphery and circumference of the plunger. The plunger may include a plunger body, a filter extending from an outer rim of the plunger body to an inner rim of the plunger body, and a threaded portion located within a cavity within the inner rim of the plunger body. The threaded portion may be connected to a second end of the connect rod.

Additionally, the lid may include a rim, a recessed surface adjacent to the rim, and a base surface adjacent to the recessed surface. The recessed surface may extend at an angle from the rim to the base surface. The rim and the base surface of the lid may be on a same plane and are parallel to each other. The vent portion may include one or more horizontal channels located on a top surface of the vent portion and/or one or more vertical channels located within the hole of the lid. The first end of the connect rod may include a first threaded portion to threadedly connect to and attach to the handle. The second end of the connect rod may include a lower flange and a second threaded portion to threadedly connect to and attach to the base assembly and the plunger. The plunger body may include one or more spokes that extend from the inner rim to the outer rim and the one or more spokes hold the filter. The valve may include a valve body with a valve hole located in a radial center of the valve body. The valve hole may receive and pass through the connect rod. The valve body may include an upper valve rim located around the valve hole on a top side of the valve body and a lower valve rim located around the valve hold on a bottom side of the valve body. The upper valve rim may engage with a lower flange located on the connect rod and the lower valve rim may engage with a spacer located on the plunger.

The insulated container may include an outer shell having an external sidewall and an outer bottom wall, an inner shell having an inner sidewall and an inner bottom wall. The outer shell can be connected to the inner shell to form an insulated double wall structure with a sealed vacuum cavity between the outer shell and the inner shell. The insulated container can include a top opening at a top of the inner sidewall that leads into a storage cavity formed by the inner sidewall and the inner bottom wall, and the top opening can include a container pour spout. The insulated container can include one of a plurality of container projections or grooves.

### BRIEF DESCRIPTION OF THE DRAWINGS

The present disclosure is illustrated by way of example and not limited in the accompanying figures in which like reference numerals indicate similar elements and in which:

FIG. 1A depicts a front perspective view of an exemplary container with an exemplary French press assembly with a plunger in the full plunge/downward orientation, according to one or more aspects described herein;

FIG. 1B depicts a front perspective view of the container and the French press assembly from FIG. 1A with the plunger in the full extract/upward orientation, according to one or more aspects described herein;

FIG. 1C depicts a cross-sectional view of the container and the French press assembly from FIG. 1A, according to one or more aspects described herein;

FIG. 2 depicts a top perspective view of the French press assembly of FIG. 1A, according to one or more aspects described herein;

FIG. 3A depicts a side view of the French press assembly of FIG. 1A, according to one or more aspects described herein;

FIG. 3B depicts a cross-sectional view of the French press assembly of FIG. 1A along line 3B-3B from FIG. 3A, according to one or more aspects described herein;

FIG. 3C depicts a close up view of an exemplary lid assembly from the cross-sectional view of the French press assembly from FIG. 3B, according to one or more aspects described herein;

FIG. 3D depicts a close up view of an exemplary base assembly from the cross-sectional view of the French press assembly from FIG. 3B, according to one or more aspects described herein;

FIG. 4 depicts an exploded component view of the French press assembly and the insulated container from FIG. 1A, according to one or more aspects described herein;

FIGS. 5A and 5B depict various views of an exemplary handle of the French press assembly of FIG. 1A, according to one or more aspects described herein;

FIGS. 6A-6G depict various views of an exemplary lid of the French press assembly of FIG. 1A, according to one or more aspects described herein;

FIGS. 6H-6L depict various views of another exemplary lid of the French press assembly of FIG. 1A, according to one or more aspects described herein;

FIGS. 7A and 7B depict various views of an exemplary connect rod of the French press assembly of FIG. 1A, according to one or more aspects described herein;

FIGS. 8A-8F depict various views of an exemplary base assembly of the French press assembly of FIG. 1A, according to one or more aspects described herein;

FIGS. 9A-9E depict various views of an exemplary plunger of the French press assembly of FIG. 1A, according to one or more aspects described herein;

FIGS. 10A and 10B depict various views of an exemplary valve of the French press assembly of FIG. 1A, according to one or more aspects described herein;

FIG. 10C depicts a cross-sectional view of the base assembly and the valve of the French press assembly of FIG. 1A during plunging, according to one or more aspects described herein;

FIG. 10D depicts a cross-sectional view of the base assembly and the valve of the French press assembly of FIG. 1A when extraction is completed, according to one or more aspects described herein;

FIG. 11 depicts a top-perspective view of an exemplary gasket of the French press assembly of FIG. 1A, according to one or more aspects described herein;

FIG. 12 depicts a right perspective view of an exemplary container to be used with a French press assembly, according to one or more aspects described herein;

FIG. 13 depicts a left-side view of the container of FIG. 12, according to one or more aspects described herein;

FIG. 14 depicts a front view of the container of FIG. 12, according to one or more aspects described herein, according to one or more aspects described herein;

FIG. 15 depicts a cross-sectional view of the container of FIG. 12 along line 15-15 in FIG. 13, according to one or more aspects described herein;

FIG. 16A depicts an exploded component view of another exemplary French press assembly, according to one or more aspects described herein;

FIG. 16B depicts a cross-sectional view of the container and the French press assembly from FIG. 16A, according to one or more aspects described herein;

FIG. 17A depicts an exploded component view of another exemplary French press assembly, according to one or more aspects described herein;

FIG. 17B depicts a cross-sectional view of the container and the French press assembly from FIG. 17A, according to one or more aspects described herein;

FIG. 18A depicts an exploded component view of another exemplary French press assembly, according to one or more aspects described herein;

FIG. 18B depicts a cross-sectional view of the container and the French press assembly from FIG. 18A, according to one or more aspects described herein; and

FIGS. 19A-19F depict various steps of utilizing the French press assembly and container, according to one or more aspects described herein.

Further, it is to be understood that the drawings may represent the scale of different components of various examples; however, the disclosed examples are not limited to that particular scale.

### DETAILED DESCRIPTION

In the following description of the various examples, reference is made to the accompanying drawings, which form a part hereof, and in which is shown by way of illustration various examples in which aspects of the disclosure may be practiced. It is to be understood that other examples may be utilized and structural and functional modifications may be made without departing from the scope and spirit of the present disclosure. Also, while the terms “top.” “bottom,” “front.” “side.” “rear.” and the like may be used in this specification to describe various example features and elements of the examples, these terms are used herein as a matter of convenience, e.g., based on the example orientations shown in the figures or the orientation during typical use. Nothing in this specification should be construed as requiring a specific three-dimensional orientation of structures in order to fall within the scope of this disclosure.

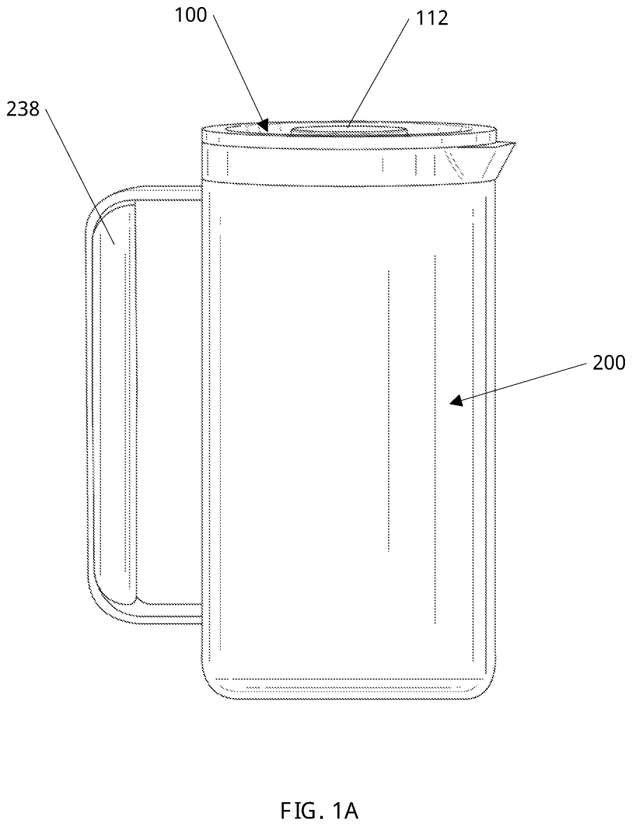

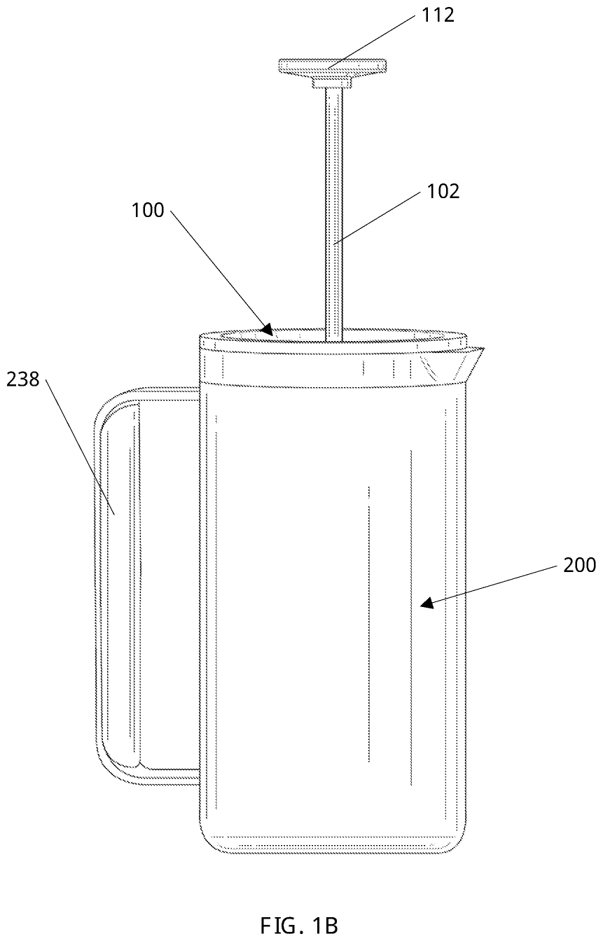

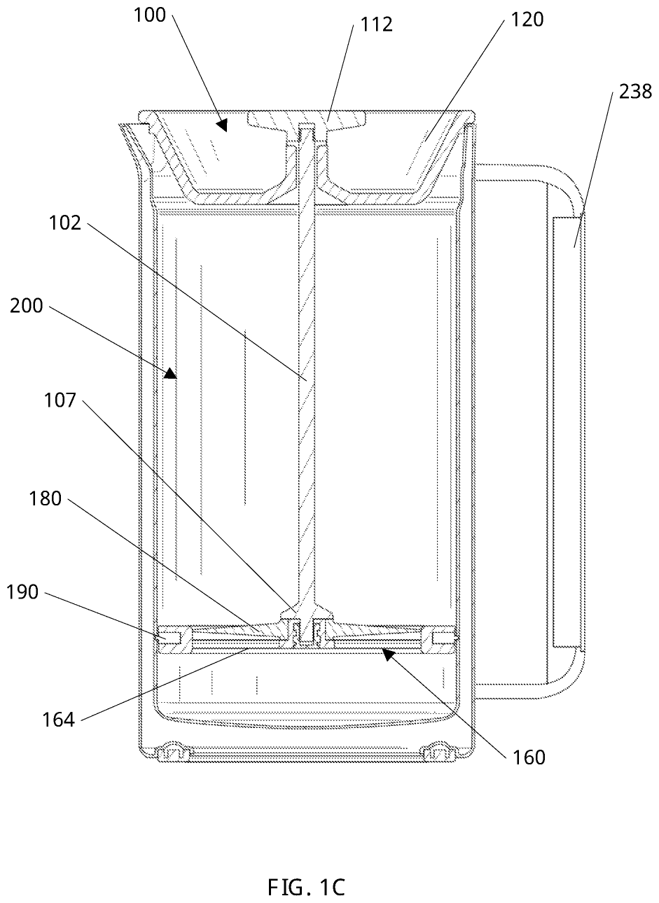

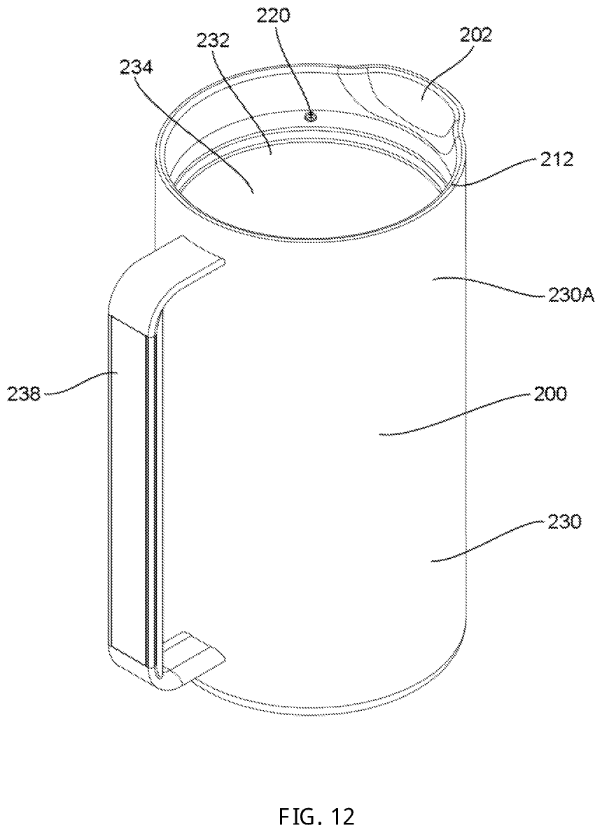

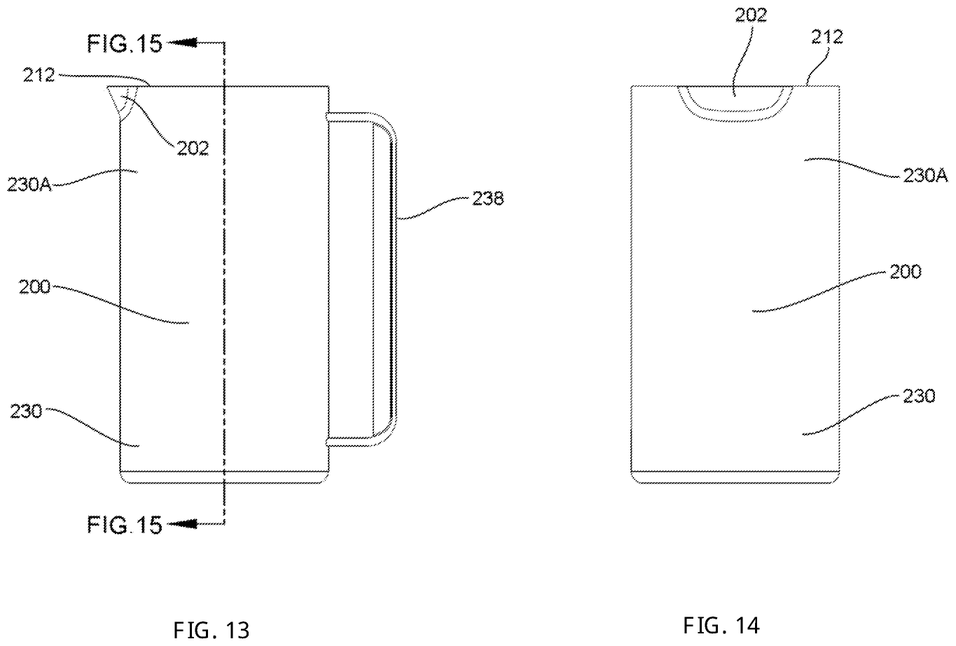

Aspects of this disclosure relate to a French press assembly 100 and an insulated container 200. FIGS. 1A-11 depict a French press assembly 100 and FIGS. 12-15 depict an insulated container 200. The insulated container 200 may function as a container or pitcher for liquids, beverages, ice, foods, etc. In the example French press assembly 100 of FIGS. 1A-11, the French press assembly 100 can be configured to be secured to the container 200, such that the French press assembly 100 does not easily come off of the container 200 during use of the container 200. The example French press assembly 100 can be configured to be removably fastened to the container 200. FIGS. 1A-1C illustrate an exemplary French press assembly 100 with an exemplary container 200. FIG. 1A illustrates a front perspective view of the container 200 with the French press assembly 100 and plunger in the full plunge/downward orientation. FIG. 1B illustrates a front perspective view of the container 200 with the French press assembly 100 and plunger in the full extract/upward orientation. FIG. 1C illustrates a cross-sectional view of the container 200 with the French press assembly 100.

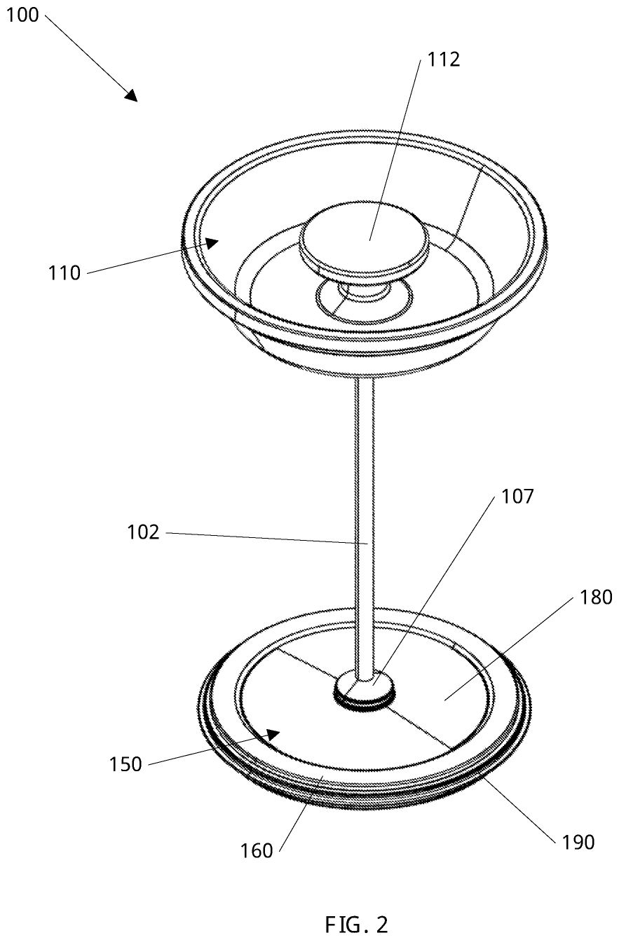

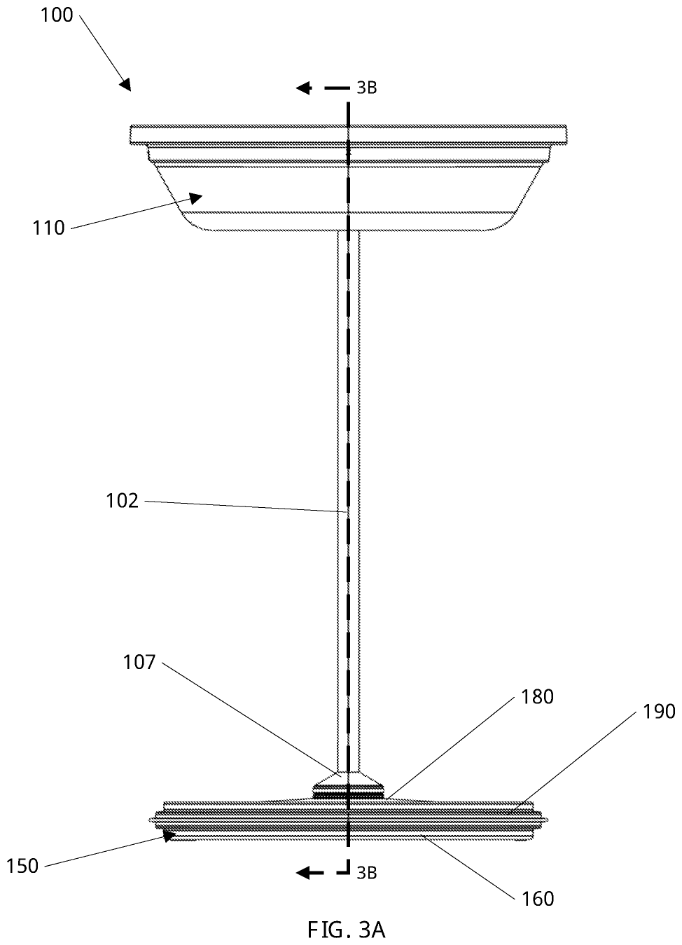

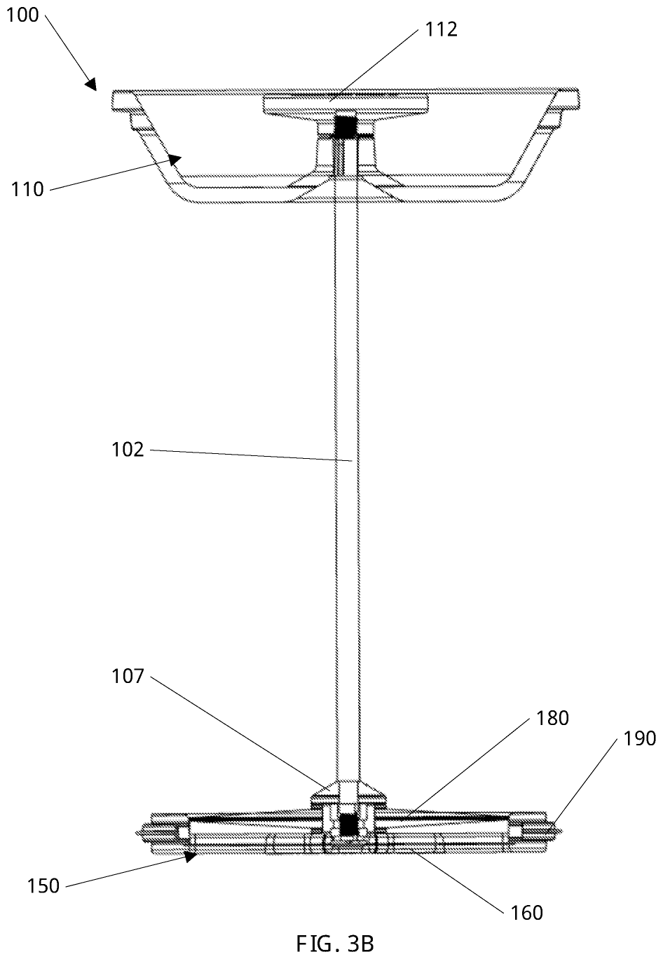

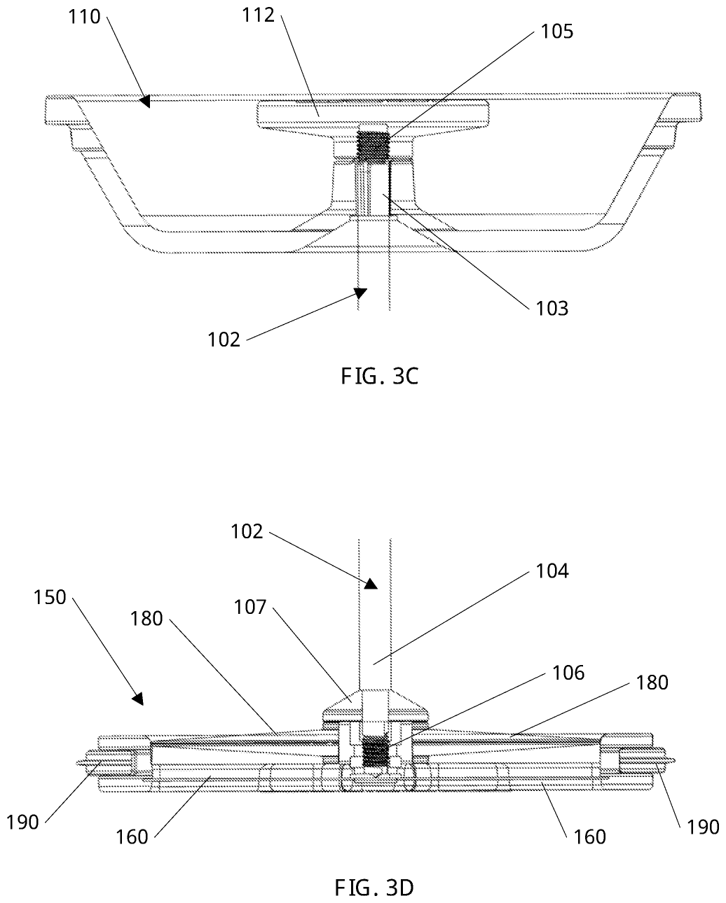

Turning specifically to the French press assembly 100, in one example, as shown in FIGS. 2-4, the French press assembly 100 includes a lid assembly 110 and a base assembly 150. FIG. 2 illustrates top perspective view of the French press assembly 100. FIG. 3A illustrates a side view of the French press assembly 100. FIG. 3B illustrates a cross-sectional view of the French press assembly 100 along line 3B-3B from FIG. 3A. FIG. 3C illustrates a close up view of the lid assembly 110 from the cross-sectional view from FIG. 3B. FIG. 3D illustrates a close up view of the base assembly 150 from the cross-sectional view from FIG. 3B. As illustrated in these figures, the lid assembly 110 and the base assembly 150 may be connected by a connect rod 102. The connect rod 102 may include one or more connections methods to connect to the lid assembly 110 and the base assembly 150 as will be explained in more detail below.

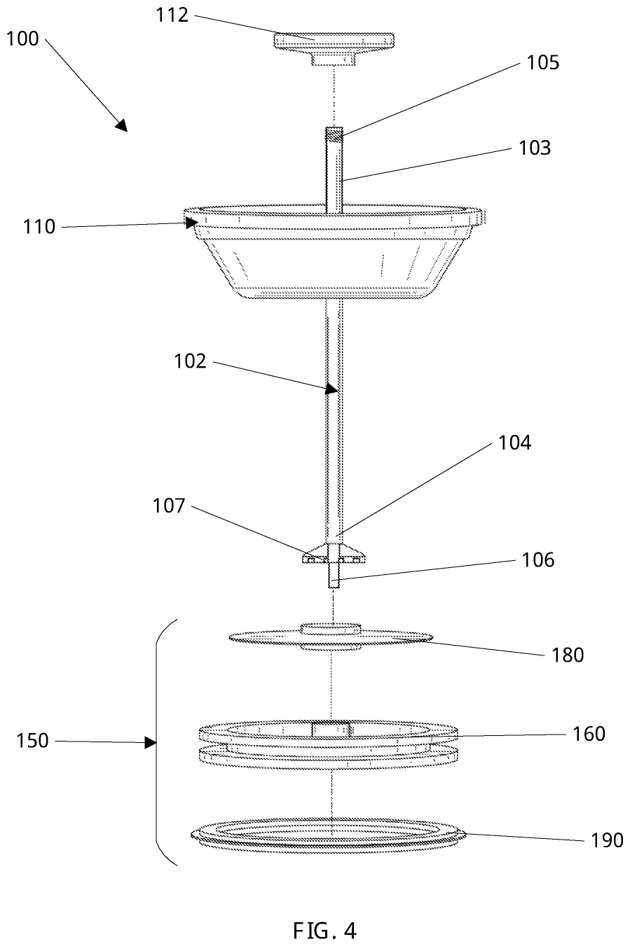

FIG. 4 illustrates an exploded component view of the French press assembly 100 and the insulated container 200. The French press assembly 100 may include the lid assembly 110 and the base assembly 150 connected by the connect rod 102. The lid assembly 110 may include a handle 112 and a lid 120. The handle 112 may be connected to a first end 103 of the connect rod 102. The lid 120 may be slidably connected to the connect rod 102. The base assembly 150 may be connected to a second end 104 of the connect rod 102. The base assembly 150 may include a plunger 160 with a valve 180 and a wiper gasket 190. The plunger 160 may be connected to the second end 104 of the connect rod 102. The valve 180 may be located on a top side of the plunger 160. The wiper gasket 190 may be located around a periphery of the plunger 160. Further details of each of these components will be explained in more detail below.

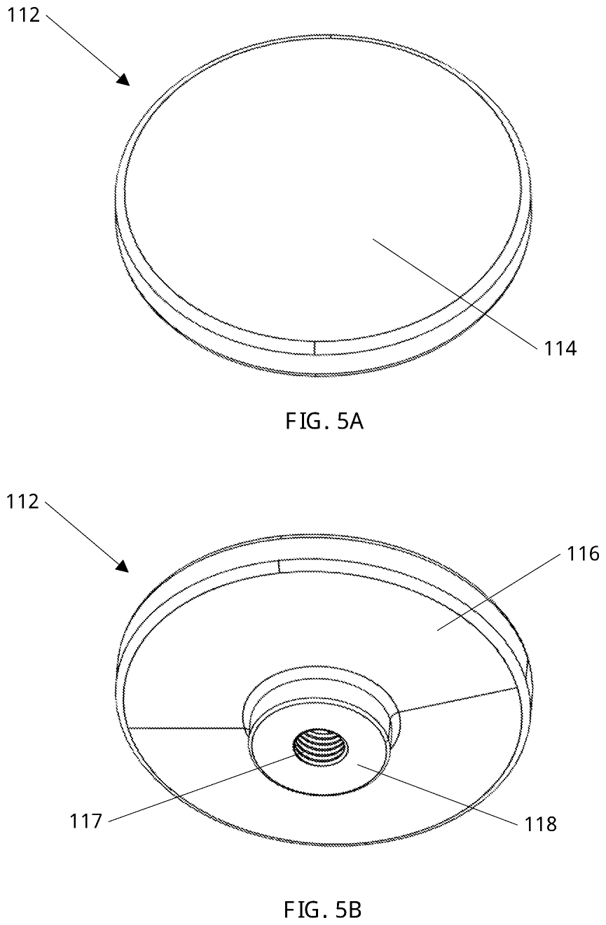

FIGS. 5A and 5B illustrate an exemplary handle 112 or knob that may be utilized with the lid assembly 110 and the French press assembly 100. FIG. 5A illustrates a top-perspective view of the handle 112 and FIG. 5B illustrates a bottom-perspective view of the handle 112. As illustrated in FIGS. 5A and 5B, the handle 112 may be in the form of a circular shaped knob. Other shapes for the handle 112 could be used without departing from this disclosure, such as oval, square, rectangular, etc. The handle 112 may include a top surface 114 and a bottom surface 116. The handle 112 may also include a threaded hole 117 that extends from and through the bottom surface 116. The threaded hole 117 may be configured to threadedly attach to and connect to the connect rod 102. The bottom surface 116 may also include a cylindrical protrusion 118 extending from the bottom surface 116 and forming a portion of the threaded hole 117. The cylindrical protrusion 118 may create a gap/stand-off between the handle 112 and the lid 120.

The handle 112 can be removed for disassembly and cleaning. The handle 112 may generally sit below the top of the lid 120, preventing the handle 112 from punching through the lid 120 if the lid 120 or French press 100 is dropped. The handle 112 should be sized to be comfortable for a user to push and pull the plunger 160 for the French press 100 during the extraction and plunging steps. The handle 112 can be formed of a stainless steel or titanium, for example, or other equivalent material. The handle 112 may be formed, for example, of 18/8 kitchen-grade stainless steel or SUS 304. The handle 112 may be formed from food safe materials without departing from this disclosure. The top surface 114 can also include a logo that is formed and/or embossed within the top surface 114 of the handle. The logo may also be formed of TPU and welded onto the handle 112. In another example, the top surface 114 can include a heat transfer logo.

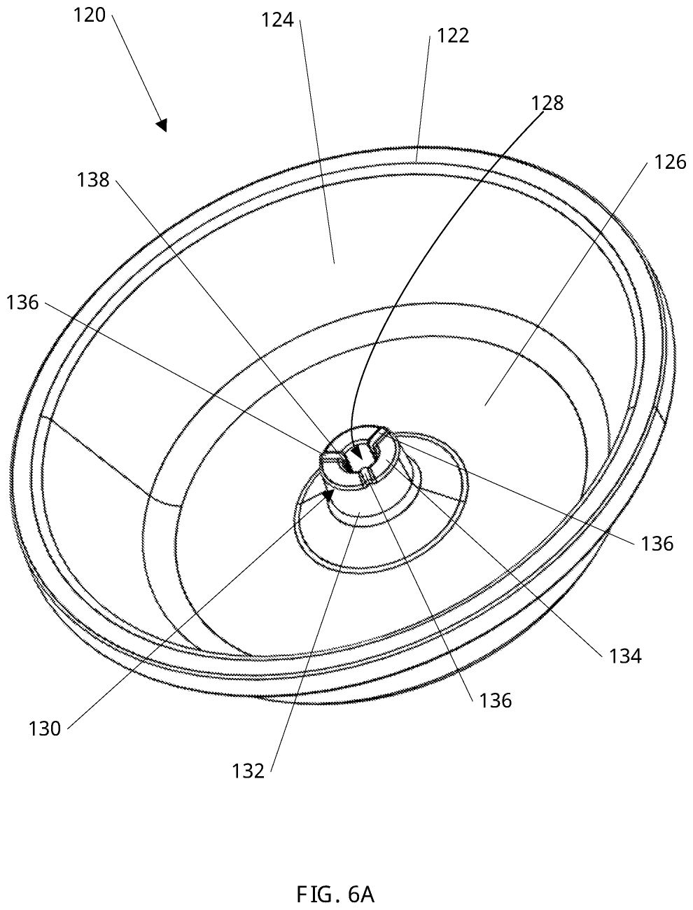

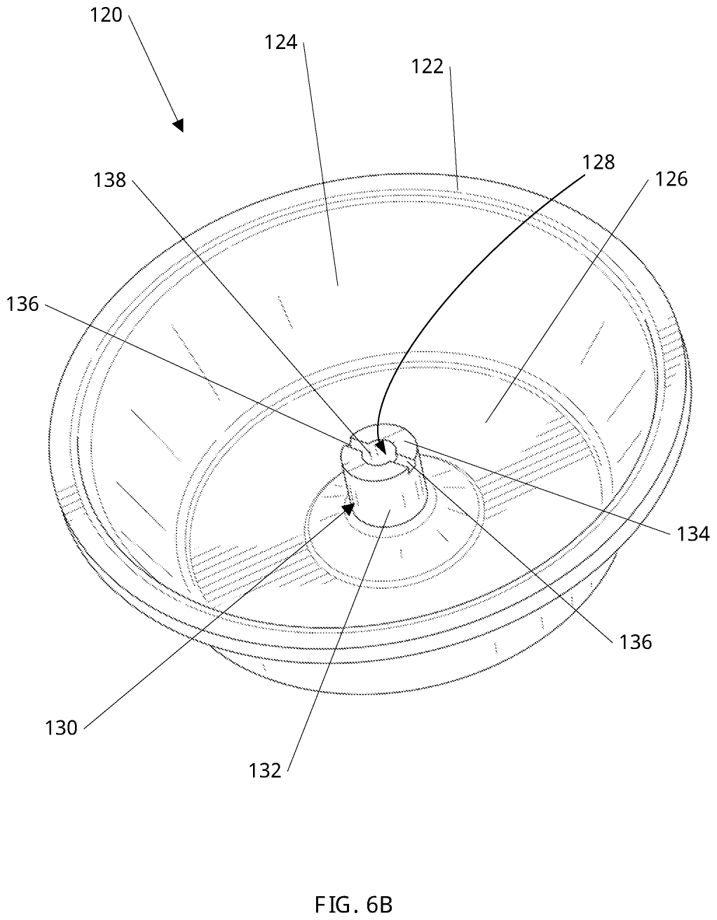

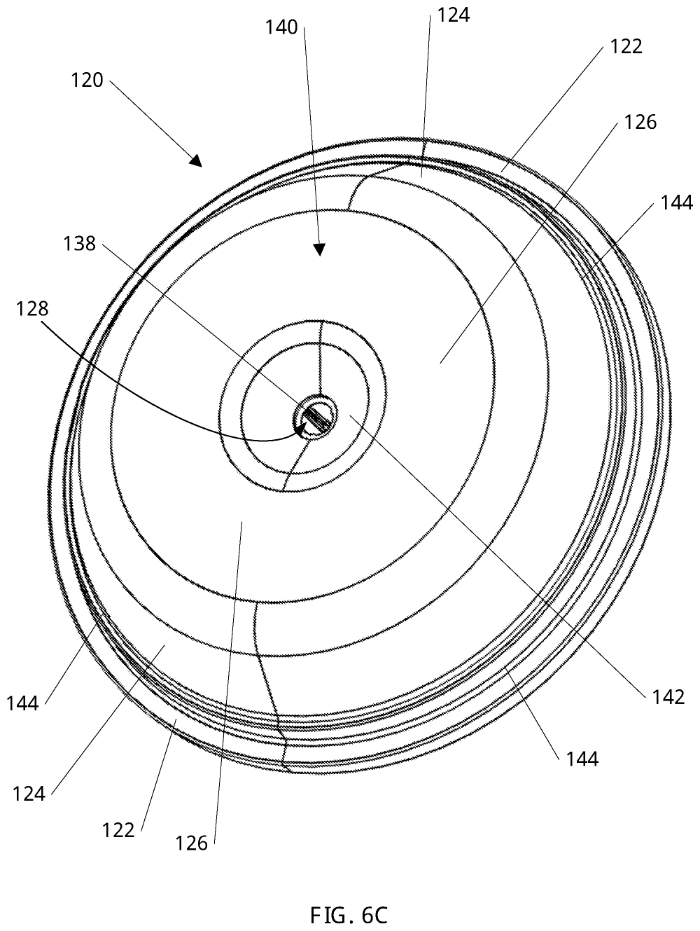

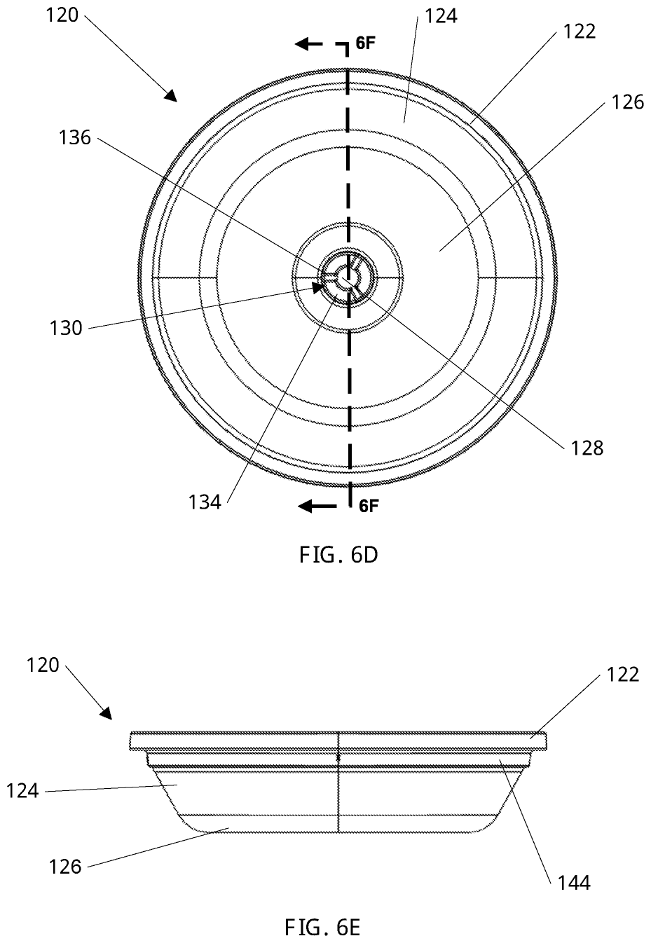

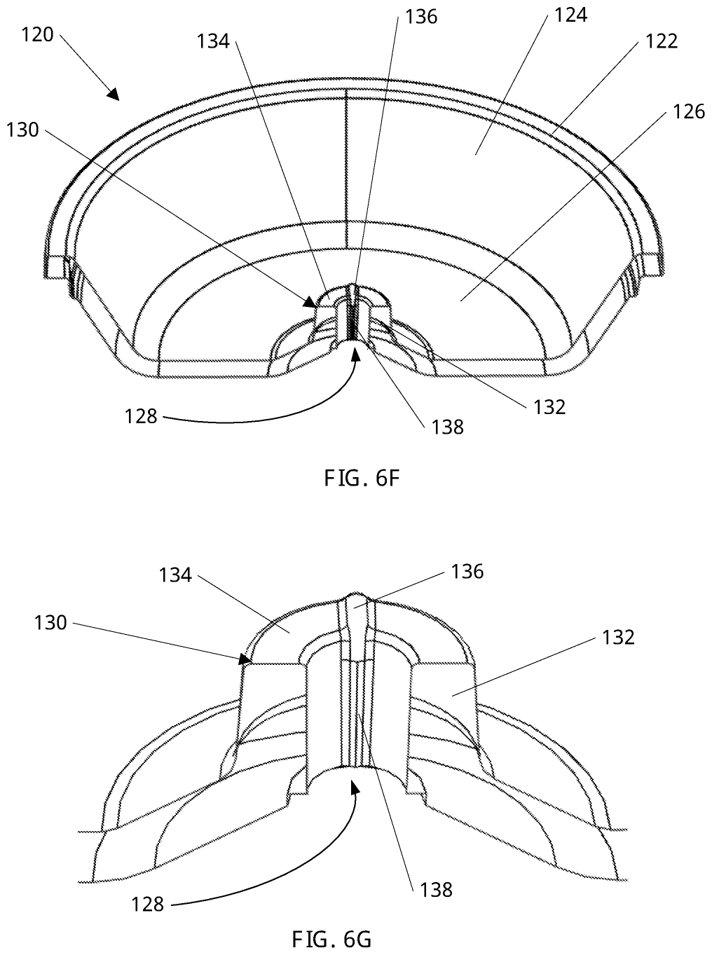

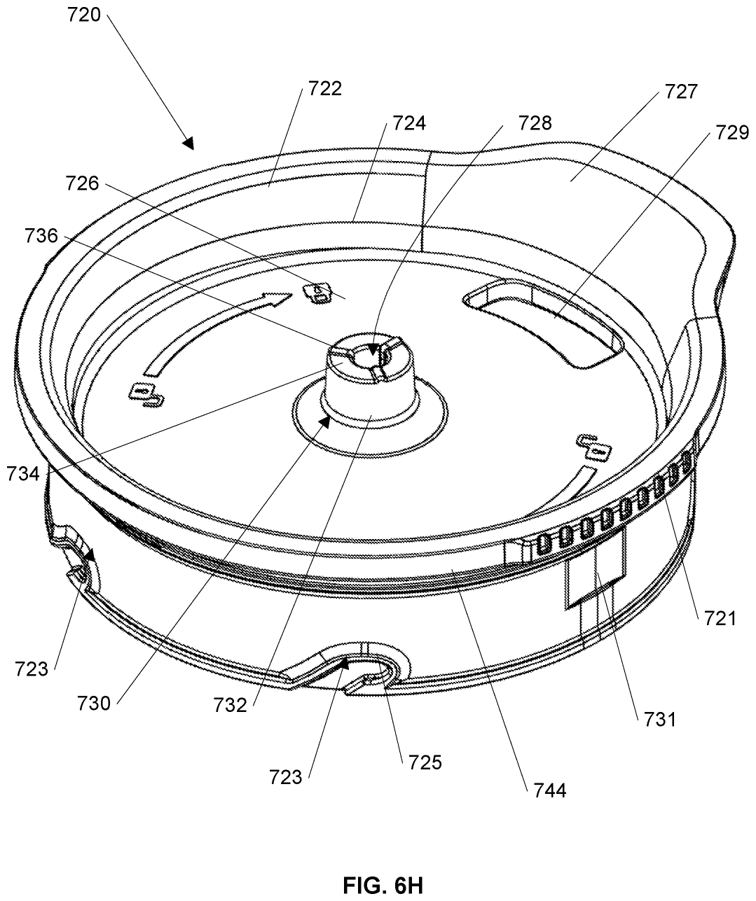

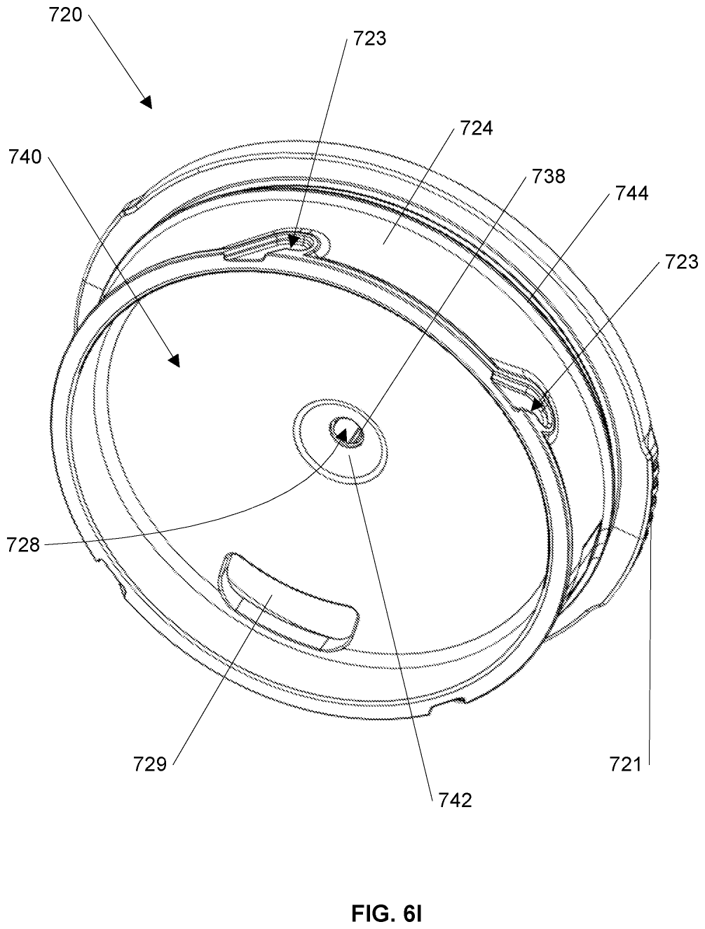

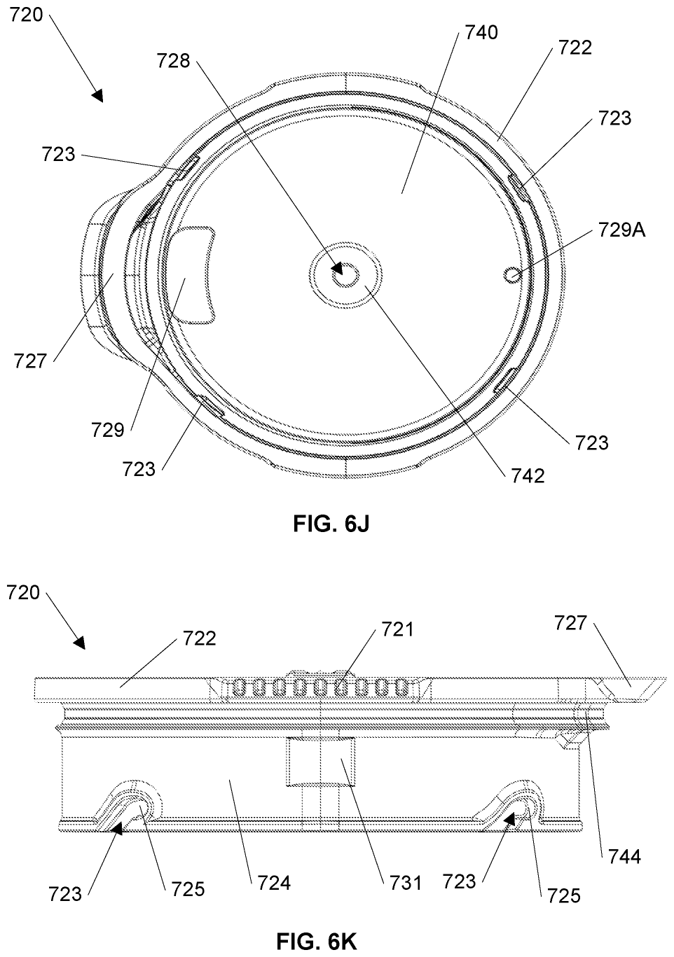

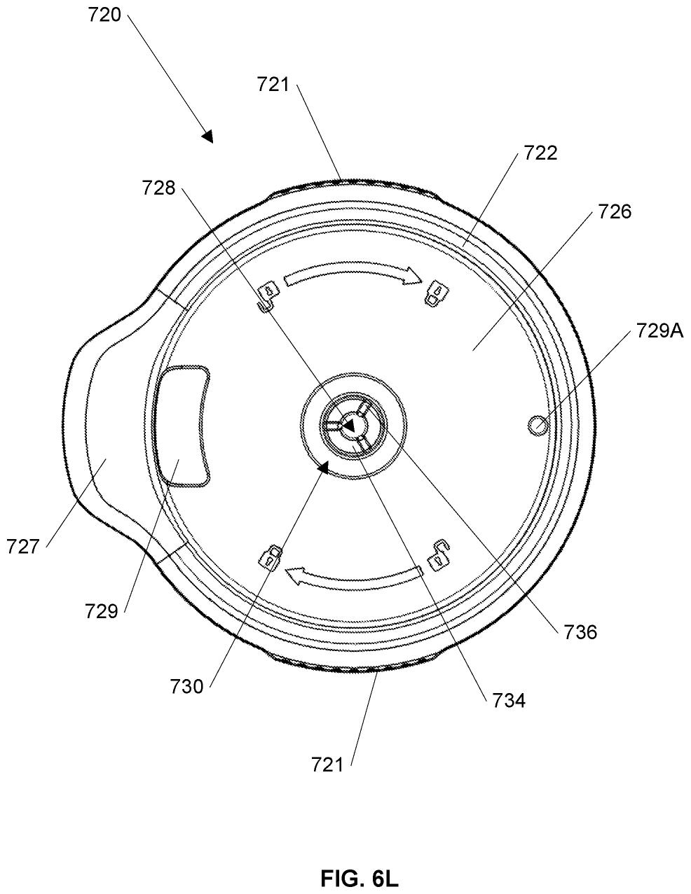

FIGS. 6A-6G illustrate an exemplary lid 120 that may be utilized with the lid assembly 110 and the French press assembly 100. FIG. 6A illustrates a top-perspective view of the lid 120. FIG. 6B illustrates a top-perspective view of another exemplary lid 120. FIG. 6C illustrates a bottom-perspective view of the lid 120. FIG. 6D illustrates a top view of the lid 120. FIG. 6E illustrates a side view of the lid 120. FIG. 6F illustrates a cross-sectional view along 6F-6F from FIG. 6D of the lid 120. FIG. 6G illustrates a close-up view from a portion of FIG. 6F.

As illustrated in FIGS. 6A-6G, the lid 120 may be in the form of a circular-shaped recessed lid. Other shapes for the lid 120 could be used without departing from this disclosure, such as oval, square, rectangular, etc. However, the lid 120 is configured to match and mate with the upper end of the container 200. The lid 120 may provide a 360-degree gasket-less cover and seal for the container 200 which allows for an easy work flow and a familiar experience for the user with the French press assembly 100 and the container 200.

The lid 120, as illustrated in FIGS. 6A and 6D, on a top-side, may include a rim 122, a recessed surface 124 adjacent to the rim 122, and a base surface 126 adjacent to the recessed surface 124. Generally, the rim 122 and the base surface 126 may be on the same plane and/or may be parallel to each other. The recessed surface 124 may extend at an angle from the rim 122 to the base surface 126. The rim 122 may be configured to extend above and engage with a container rim 212 of the container 200 when assembled to the container 200. Additionally, the lid 120 may include a sliding hole 128 configured to receive and pass through the connect rod 102. The sliding hole 128 may be located at a radial center of the base surface 126, wherein the sliding hole 128 receives and passes through the connect rod 102. For example, the connect rod 102 may be inserted through the sliding hole 128 of the lid 120, such that during operation, the user slides the connect rod 102 up and down within the sliding hole 128 for operation and plunging of the plunger 160 and the French press assembly 100. The sliding hole 128 shall have a diameter slightly larger than the diameter of the connect rod 102.

As further illustrated in FIGS. 6A, 6B, 6D, 6F and 6G, the lid 120 may also include a vent portion 130 located within the center of the lid 120 and along the base surface 126. The vent portion 130 may extend around the sliding hole 128 along a radial center of the base surface 126. The vent portion 130 may include a recessed portion 132 and a top surface 134. The vent portion 130 may be a specialty “key”-shaped vent that prevents glugging when pouring the beverage/coffee from the container 200. The “key” shape may be in the shape of keyways which may include slots, grooves, notches, or openings, etc. The vent portion 130 may include horizontal channels 136 and/or vertical channels 138 that allow air to escape during pouring and creates a smooth pouring experience for the user. The horizontal channels 136 and the vertical channels 138 may be vents or slots without departing from the invention. The horizontal channels 136 may be located on the top surface 134 of the vent portion 130. The horizontal channels 136 may extend along the entire portion of the top surface 134 of the vent portion 130 or less than the entire portion of the top surface 134 of the vent portion 130. The vertical channels 138 may be located within the sliding hole 128 of the lid 120. The vertical channels 138 may extend along the entire portion of the sliding hole 128 of the lid 120 or less than the entire portion of the sliding hole 128 of the lid 120. As illustrated in FIGS. 6A, 6D, 6F, and 6G, the horizontal channels 136 and the vertical channels 138 may include three horizontal channels 136 and three vertical channels 138 located equidistant around the top surface 134 of the vent portion 130 and the sliding hole 128 of the lid 120. As illustrated in FIG. 6B, the horizontal channels 136 and the vertical channels may include two horizontal channels 136 and two vertical channels 138 located across from each other and forming a line along the top surface 134 of the vent portion 130 and the sliding hole 128 of the lid 120. Other configurations of horizontal channels 136 and vertical channels 138 may be utilized without departing from this disclosure, such as for example, four horizontal channels 136 and four vertical channels 138 located equidistant and forming a cross along the top surface 134 of the vent portion 130 and the sliding hole 128 of the lid 120, or other examples not described and detailed in this disclosure.

FIG. 6C illustrates a bottom surface 140 of the lid 120. The bottom surface 140 may include a bottom recess 142 that recesses inward and upward from the base 126 of the lid 120. The sliding hole 128 projects through the bottom surface 140 and within the bottom recess 142. Additionally, from this view in FIG. 6C, the vertical channels 138 are shown within the sliding hole 128. The bottom recess 142 may be sized and shaped to match with and mate with a lower flange 107 on the connect rod 102 when the connect rod 102 and plunger 160 are in the extract and upward configuration. When the plunger 160 is in the full-extract configuration within the container 200, the lower flange 107 on the connect rod 102 matches and sits within the bottom recess 142 of the lid 120. The bottom surface 140 of the lid 120 may include various ridges and indentations 144 located along and around the circumference of the outside of the bottom surface 140 to form a 360-degree gasket-less seal with the container 200.

FIGS. 6H-6L illustrate another exemplary lid 720 that may be utilized with the lid assembly 110 and the French press assembly 100. For the embodiments of FIGS. 6H-6L, the features of the lid are referred to using similar reference numerals under the “72x” series of reference numerals, rather than “12x” as used in the embodiment of FIGS. 6A-6G. Accordingly, certain features of the lid 720 that were already described above with respect to the lid 120 of FIGS. 6A-6G may be described in lesser detail, or may not be described at all. Additionally, the lid 720 may be used with any of the other lid assemblies, containers and/or French press assemblies as described. FIG. 6H illustrates a top-perspective view of the lid 720. FIG. 6I illustrates a bottom-perspective view of the lid 720. FIG. 6J illustrates a bottom view of the lid 720. FIG. 6K illustrates a top view of the lid 720. FIG. 6L illustrates a side view of the lid 720.

As illustrated in FIGS. 6H-6L, the lid 720 may be in the form of a circular-shaped recessed lid. Other shapes for the lid 720 could be used without departing from this disclosure, such as oval, square, rectangular, etc. The lid 720 is configured to match and mate with the upper end of the container 200. The lid 720 may provide a 360-degree gasket-less cover and seal for the container 200 which allows for an easy work flow and a familiar experience for the user with the French press assembly 100 and the container 200.

The lid 720, as illustrated in FIGS. 6H and 6L, on a top-side, may include a rim 722, a side wall surface 724 adjacent to the rim 722, and a base surface 726 adjacent to the side wall surface 724. Generally, the rim 122 and the base surface 126 may be on the same plane and/or may be parallel to each other. The side wall surface 724 may be approximately perpendicular from the rim 722 and extend to the base surface 726. The side wall surface 724 may also extend at an angle from the rim 722 to the base surface 726. The rim 722 may be configured to extend above and engage with a container rim 212 of the container 200 when assembled to the container 200. The rim 722 may also include one or more ridge portions 721. The ridge portions 721 may be located at areas around the circumference of the rim 722. For example, the rim 722 may include two ridge portions 721 (as illustrated in the figures) located opposite one another on the circumference of the rim 722. The rim 722 may also include a drink spout 727. The drink spout 727 may be sized and shaped to help with the user to drink from the container 200. The base surface 726 may also include a drink opening 729. The drink opening 729 may be sized and shaped to allow the user to drink from the container 200. The base surface 726 may also include a vent hole 729A opposite the drink opening 729.

Additionally, as shown in FIGS. 6H, 6I, 6J, and 6K, the side wall surface 724 may include one or more locking slots 723. The locking slots 723 may be openings located in the side wall surface 724 that correspond to and communicate with one or more locking protrusions on the container 200. The locking slots 723 may also include a locking hole 725 for final locking of the lid 720 with the container with the locking protrusion sliding into the locking hole 725. The lid 720 may be rotated to line up the one or more locking slots 723 with the locking protrusions on the container 200. The lid 720 may then be twisted to a locking position within the container 200 thereby securing the locking protrusion within the locking slot 723 and the locking hole 725. The lid 720 shown in the figures includes four locking slots 723, but other numbers of locking slots may be utilized, such as two, three, five, six, etc. The locking slots 723 may be other shapes without departing from this invention. As shown in FIGS. 6H and 6K, the side wall surface 724 may include one or more flat portions 731. The flat portion 731 may be provided for the gate to help having the fill point be flat.

Additionally, the lid 720 may include a sliding hole 728 configured to receive and pass through the connect rod 102. The sliding hole 728 may be located at a radial center of the base surface 726, wherein the sliding hole 728 receives and passes through the connect rod 102. For example, the connect rod 102 may be inserted through the sliding hole 728 of the lid 720, such that during operation, the user slides the connect rod 102 up and down within the sliding hole 728 for operation and plunging of the plunger 160 and the French press assembly 100. The sliding hole 728 shall have a diameter slightly larger than the diameter of the connect rod 102.

As further illustrated in FIGS. 6H and 6L, the lid 720 may also include a vent portion 730 located within the center of the lid 720 and along the base surface 726. The vent portion 730 may extend around the sliding hole 728 along a radial center of the base surface 726. The vent portion 730 may include a recessed portion 732 and a top surface 734. The vent portion 730 may be a specialty “key”-shaped vent that prevents glugging when pouring the beverage/coffee from the container 200. The “key” shape may be in the shape of keyways which may include slots, grooves, notches, or openings, etc. The vent portion 730 may include horizontal channels 736 and/or vertical channels 738 that allow air to escape during pouring and creates a smooth pouring experience for the user. The horizontal channels 136 and the vertical channels 738 may be vents or slots without departing from the invention. The horizontal channels 736 may be located on the top surface 734 of the vent portion 730. The horizontal channels 736 may extend along the entire portion of the top surface 734 of the vent portion 730 or less than the entire portion of the top surface 734 of the vent portion 730. The vertical channels 738 may be located within the sliding hole 728 of the lid 720. The vertical channels 738 may extend along the entire portion of the sliding hole 728 of the lid 720 or less than the entire portion of the sliding hole 728 of the lid 720. As illustrated in FIGS. 6H and 6L, the horizontal channels 736 and the vertical channels 738 may include three horizontal channels 736 and three vertical channels 738 located equidistant around the top surface 734 of the vent portion 730 and the sliding hole 728 of the lid 720. Other configurations of horizontal channels 736 and vertical channels 738 may be utilized without departing from this disclosure, such as for example, four horizontal channels 736 and four vertical channels 738 located equidistant and forming a cross along the top surface 734 of the vent portion 730 and the sliding hole 728 of the lid 720, or other examples not described and detailed in this disclosure.

FIGS. 6I and 6J illustrates a bottom surface 740 of the lid 720. The bottom surface 740 may include a bottom recess 742 that recesses inward and upward from the base 726 of the lid 720. The sliding hole 728 projects through the bottom surface 740 and within the bottom recess 742. Additionally, from this view in FIG. 6I, the vertical channels 738 are shown within the sliding hole 728. The bottom recess 742 may be sized and shaped to match with and mate with a lower flange 107 on the connect rod 102 when the connect rod 102 and plunger 160 are in the extract and upward configuration. When the plunger 160 is in the full-extract configuration within the container 200, the lower flange 107 on the connect rod 102 matches and sits within the bottom recess 742 of the lid 720. The bottom surface 740 of the lid 720 may include various ridges and indentations 744 located along and around the circumference of the outside of the bottom surface 740 to form a 360-degree gasket-less seal with the container 200.

The lid 120, 720 can be formed or molded from a clear or transparent polymer material, such as Tritan™ or other food safe polymer. The lid 120, 720 may be formed and made from other food safe materials without departing from this disclosure.

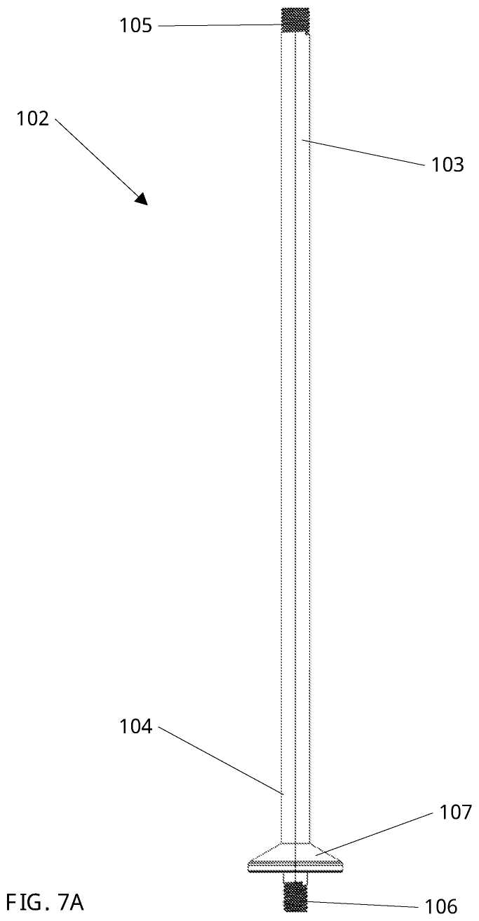

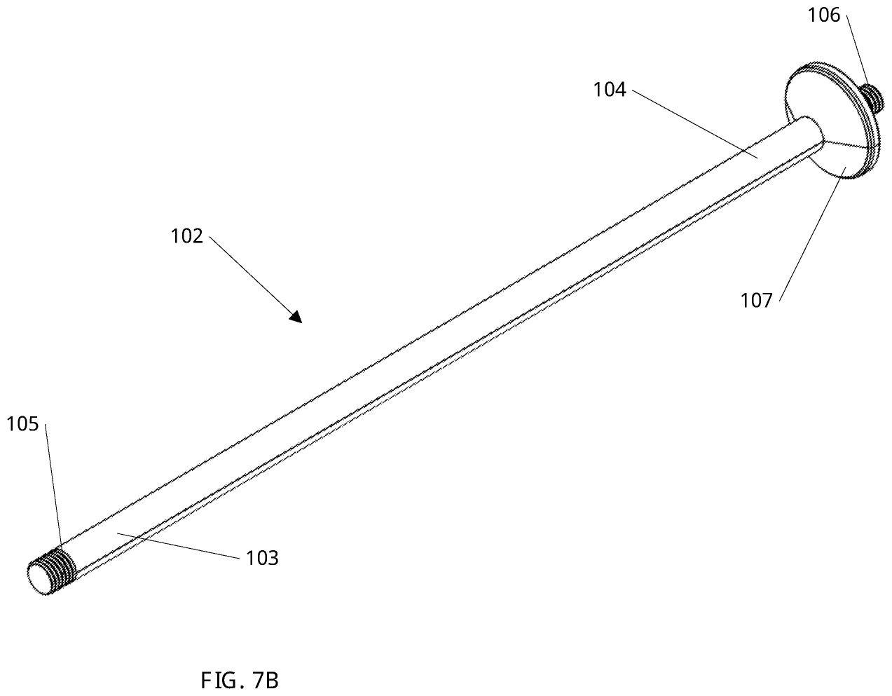

FIGS. 7A and 7B illustrate the connect rod 102 as part of the French press assembly 100. FIG. 7A illustrates a side view of the connect rod 102 and FIG. 7B illustrates a side perspective view of the connect rod 102. The connect rod 102 may be in the form of a rod with a first end 103 and a second end 104. The first end 103 of the connect rod 102 may include a first threaded portion 105 configured to threadedly connect to and attach to the handle 112. The second end 104 of the connect rod 102 may include a second threaded portion 106 configured to threadedly connect to and attach to the base assembly 150 and the plunger 160. The second end 104 of the connect rod 102 may also include a lower flange 107. The lower flange 107 may be welded to the second end 104 of the connect rod 102 or connected/attached in various other means. The lower flange 107 may be utilized to seat the base assembly 150, the plunger 160, and the valve 180 with the connect rod 102. The lower flange 107 may also be utilized to hold the connect rod 102 within the French press assembly 100 and seat against the bottom recess 142 of the lid 120 when the plunger 160 is in the full-extract configuration within the container 200.

The connect rod 102 can be formed of a stainless steel or titanium, for example, or other equivalent material. The connect rod 102 may be formed, for example, of 18/8 kitchen-grade stainless steel or SUS 304. The connect rod 102 may be formed from food safe materials without departing from this disclosure.

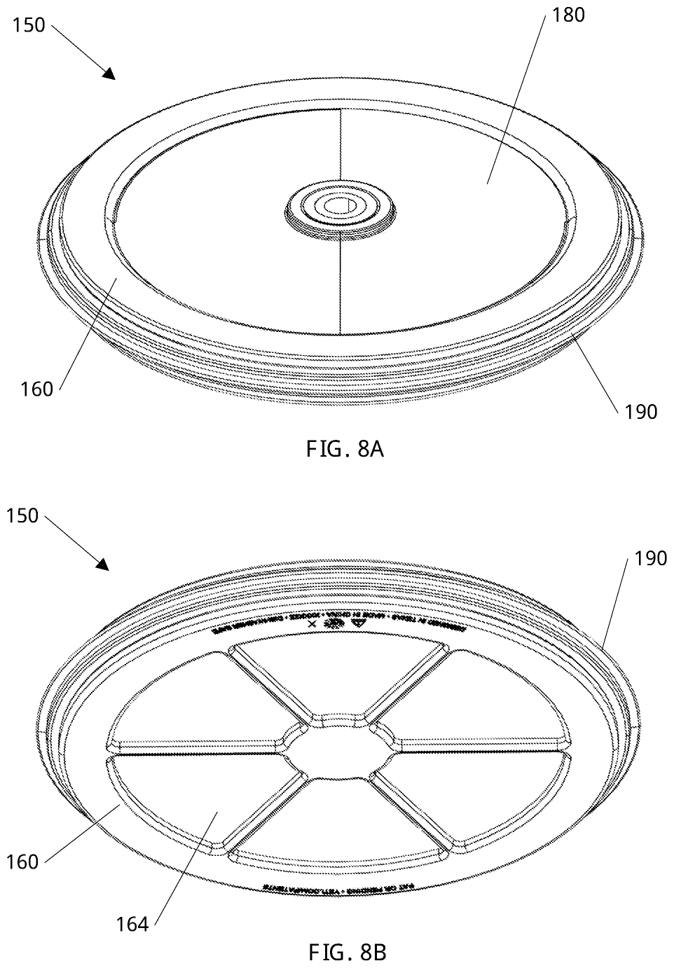

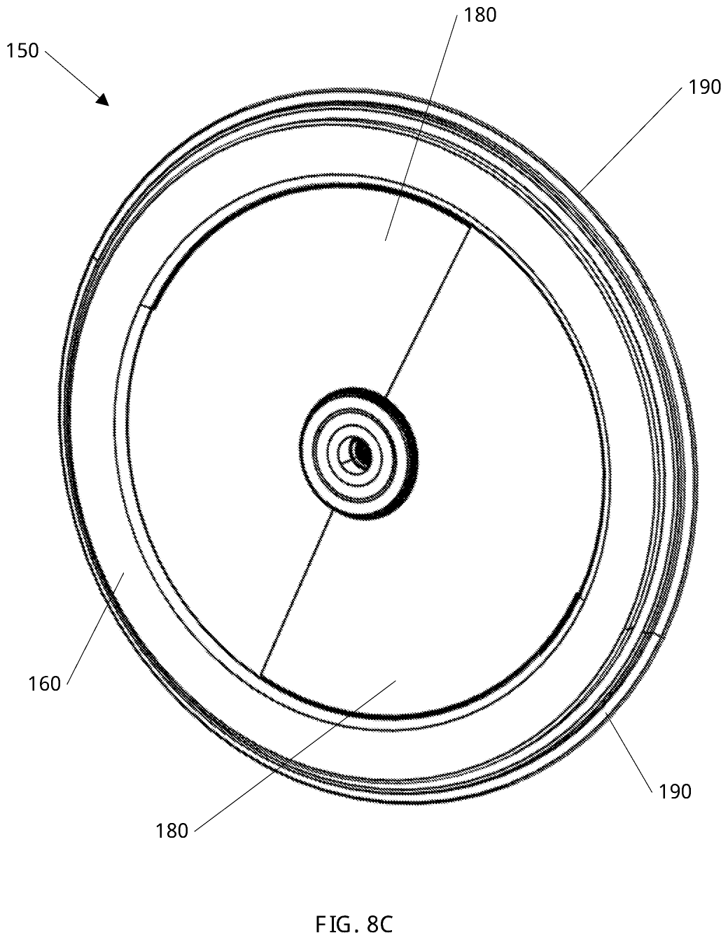

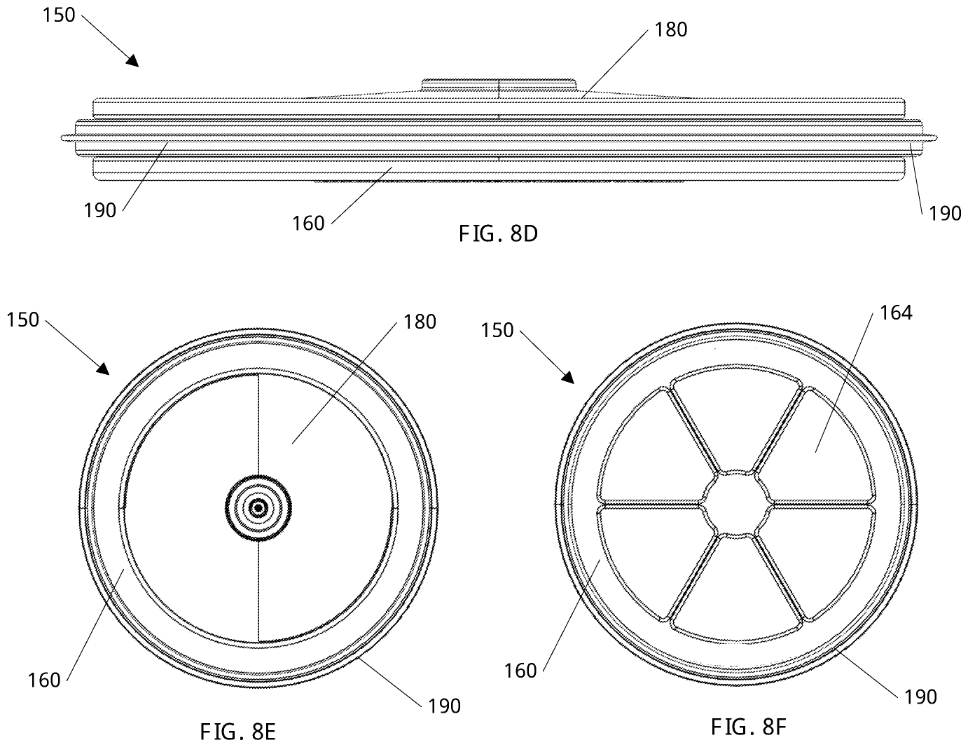

FIGS. 8A-8F illustrate an exemplary base assembly 150 that may include the components of a plunger 160 with a valve 180 and a wiper gasket 190 which may be utilized with the French press assembly 100. FIG. 8A illustrates a top-perspective view of the base assembly 150. FIG. 8B illustrates a bottom-perspective view of the base assembly 150. FIG. 8C illustrates a side top-perspective view of the base assembly 150. FIG. 8D illustrates a side view of the base assembly 150. FIG. 8E illustrates a top view of the base assembly 150. FIG. 8F illustrates a bottom view of the base assembly 150.

As illustrated in FIGS. 8A-8F, the base assembly 150 may include a plunger 160 with a valve 180 symmetrically engaged with a top portion of the plunger 160. Further, the base assembly 150 may include a wiper gasket 190 that is located around the circumference of the plunger 160 to separate the more concentrated coffee from the brewed coffee in the container.

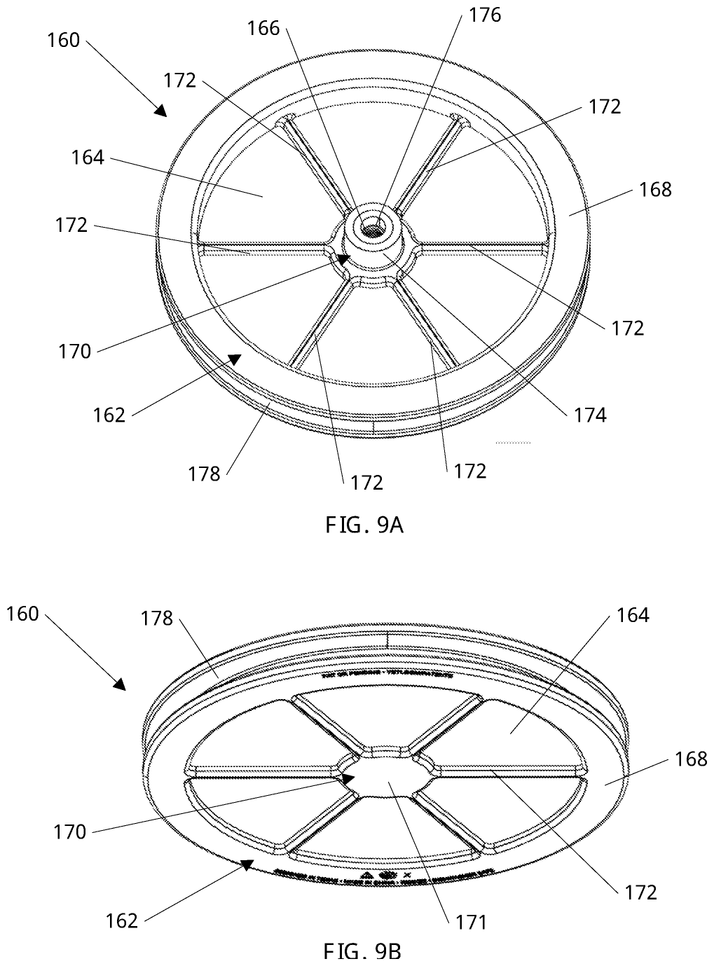

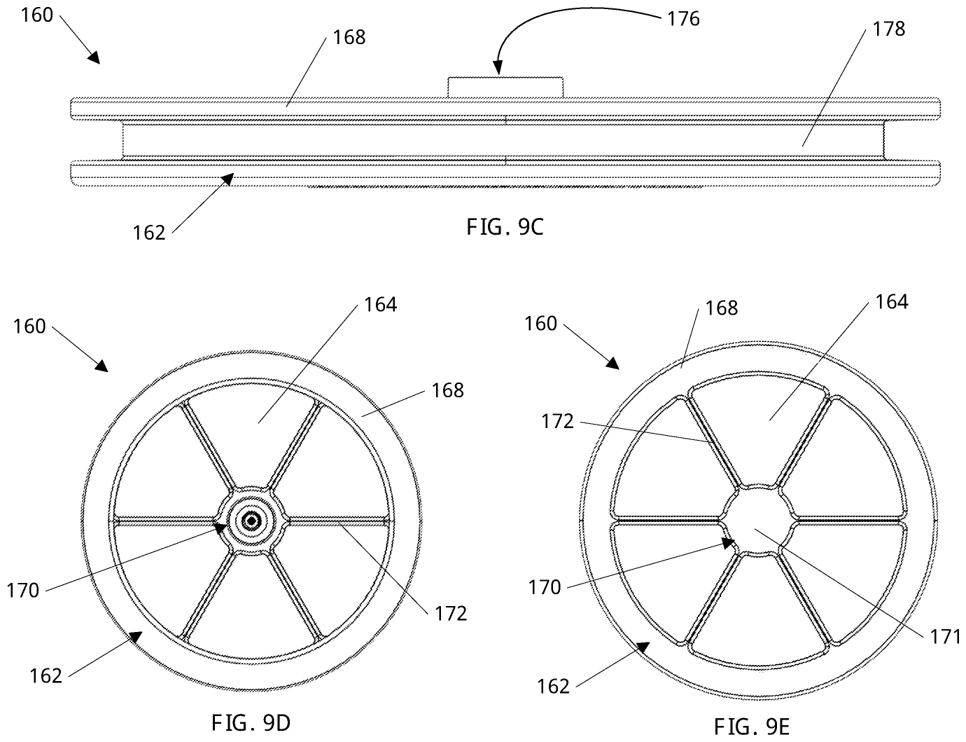

FIGS. 9A-9E illustrate an embodiment of the plunger 160. FIG. 9A illustrates a top-perspective view of the plunger 160. FIG. 9B illustrates a bottom-perspective view of the plunger 160. FIG. 9C illustrates a side view of the plunger 160. FIG. 9D illustrates a top view of the plunger 160. FIG. 9E illustrates a bottom view of the plunger 160.

The plunger 160 may be insert-molded and circular in shape. The plunger 160 may match the size and shape of the container 200. The plunger 160 may include a plunger body 162, a mesh filter 164, and a threaded portion 166. The plunger body 162 may include a wheel structure, such as a circular outer rim 168, a circular inner rim 170, an inner base 171, and one or more filter spokes 172 extending from the outer rim 168 to the inner rim 170 and inner base 171. The circular inner rim 170 may include a spacer 174 that extends from the plane of the outer rim 168 and the filter spokes 172. The spacer 174 may be sized and shaped to mate with a lower valve rim 186B of the valve 180. The circular inner rim 170 may also include a cavity 176 that retains the threaded portion 166. The spacer 174 may keep the connect rod 102 from deforming the cavity 176 and threaded portion 166 when the connect rod 102 is tightened against the plunger body 162 and plunger 160. The raised spacer 174 may also prevent the connect rod 102 and lower flange 107 from marring or damaging the valve 180 when the connect rod 102 is attached to the plunger body 162 and plunger 160.

The structure of plunger body 162 and the outer rim 168, the inner rim 170, and the one or more filter spokes 172 may provide structural integrity to the plunger body 162 and the plunger 160. As illustrated in FIGS. 9A-9E, the plunger body 162 may include a plurality of filter spokes 172 located equidistant from each other around the outer rim 168 and the inner rim 170. The plurality of filter spokes 172 may include six filter spokes 172. Also, although six filter spokes 172 are used in this example, it is contemplated that various other numbers of filter spokes 172 could be used without departing from this disclosure. Additionally, the plunger body 162 may not include any filter spokes 172. The filter spokes 172 may be various shapes and sizes without departing from this invention.

As disclosed above, the threaded portion 166 may be located within the cavity 176 within the circular inner rim 170. The threaded portion 166 may be attached to the plunger 160 and the plunger body 162 within the cavity 176 using various methods, such as glue, snap-fit, pressure-fit, or other methods known and used in the art. The threaded portion 166 may be circular and include female threads to mate with male threads of the second threaded portion 106 on the second end 104 of the connect rod 102. The threaded portion 166 may be formed of a stainless steel or titanium, for example, or other equivalent material to threadedly connect to the connect rod 102. The threaded portion 166 may be formed, for example, of 18/8 kitchen-grade stainless steel or SUS 304. The threaded portion 166 may be formed from food safe materials without departing from this disclosure.

Additionally, the plunger 160 and the plunger body 162 may include a gasket channel 178 for the wiper gasket 190. The gasket channel 178 may extend circumferentially around an outside of the plunger body 162. The gasket channel 178 may be sized and shaped to slide and stretch fit the wiper gasket 190 within the gasket channel 178. The gasket channel 178 may be U-shaped to fit the wiper gasket 190 within the gasket channel 178.

Additionally, the plunger 160 may include a mesh filter 164. The mesh filter 164 may be sized and shaped within the plunger body 162 and specifically fit within the circular outer rim 168 and the circular inner rim 170. The mesh filter 164 may also be held by the one or more filter spokes 172. The mesh filter 164 may include a filter to provide a fine mesh filtering of the coffee grounds when plunging. The mesh filter 164 may be a stainless steel mesh filter. The mesh filter 164 may also be titanium or other equivalent materials. The mesh filter 164 may be formed, for example, of 18/8 kitchen-grade stainless steel or SUS 304. The mesh filter 164 may be formed from food safe materials without departing from this disclosure. The mesh filter 164 may include a filter or strainer size of 100 mesh. It is contemplated that various other materials and filtering specifications and sizes could be used without departing from this disclosure.

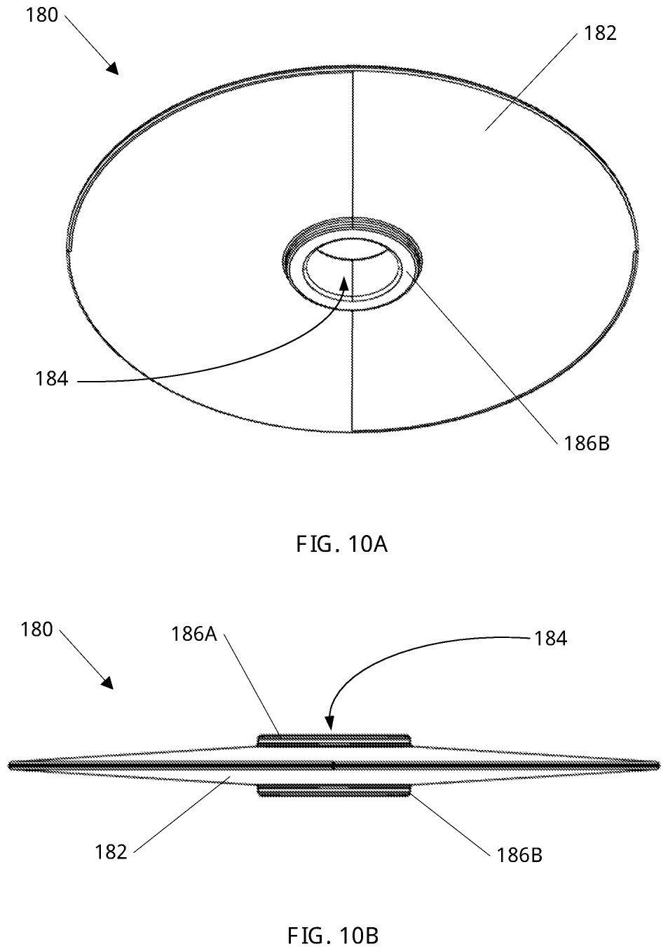

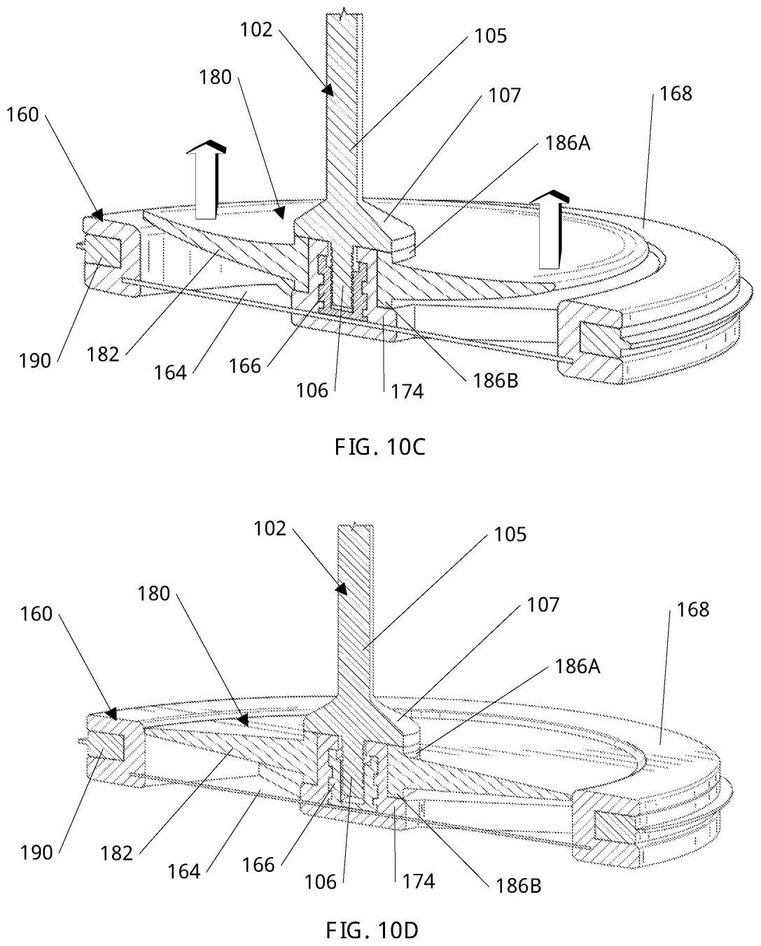

FIGS. 10A and 10B illustrate an embodiment of the valve 180. FIG. 10A illustrates a bottom-perspective view of the valve 180 and FIG. 10B illustrates a side view of the valve 180. The valve 180 may be circular in shape to match the size and shape of the plunger body 162. The valve 180 may be symmetrical to prevent improper installation. The valve 180 may allow users to keep the beverage in the container 200, shielding the brewed coffee/beverage from the grounds and preventing over-extraction.

FIGS. 10C and 10D illustrate a cross-sectional view of the base assembly 150 to include the valve 180 during plunging (FIG. 10C) and when extraction is completed (FIG. 10D). For example, as illustrated in FIG. 10C, while plunging, the valve 180 may deform upward and away from the plunger 160 as the user plunges and the mesh filter 164 will block the coffee/beverage grounds as the brewed coffee/beverage liquid passes through the mesh filter 164. As illustrated in FIG. 10D, when extraction is complete, the valve 180 may prevent over-extraction of the coffee/beverage as the valve 180 separates the brewed coffee/beverage from the plunged grounds.

The valve 180 may include a valve body 182 with a valve hole 184 located in the center of the valve body 182. The valve hole 182 may be located in a radial center of the valve body 182. The valve hole 184 may be utilized to receive and pass through the connect rod 102, when connecting the valve 180 to the plunger 160 and the base assembly 150 to the rest of the French press assembly 100. The valve 180 and valve body 182 may also include an upper valve rim 186A located around the valve hole 184 on a top side of the valve 180 and valve body 182 and/or a lower valve rim 186B located around the valve hole 184 on a bottom side of the valve 180 and valve body 182. When the connect rod 102 is threaded into the plunger 160 and the base assembly 150, the upper valve rim 186A may cooperate with and/or engage with the lower flange 107 of the connect rod 102. Additionally, when the connect rod 102 is threaded into the plunger 160 and the base assembly 150, the lower valve rim 186B may cooperate with and/or engage with the spacer 174 of the plunger 160. The internal rims 186A, 186B on the valve 180 may provide a stand-off/spacer for the engagement with the connect rod 102 and the plunger 160.

The valve 180 may be formed of silicone, for example, or other equivalent material to deform and form around the plunger 160 and mesh filter 164. The valve 180 may be formed from other materials and other food safe materials without departing from this disclosure. In another example, the valve 180 may be formed of a compressible elastomeric material, such as a silicone-based material, neoprene, nitrile, EPDM, or a rubber-based food-safe material. However, additional or alternative polymeric materials may be used for the valve 180, without departing from the scope of this disclosure.

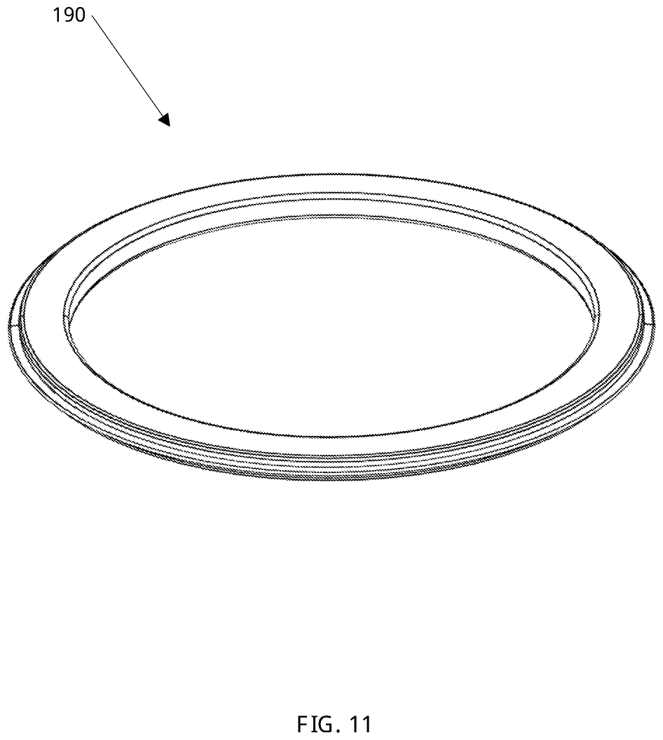

FIG. 11 illustrates an embodiment of the wiper gasket 190. FIG. 11 illustrates a top-perspective view of the wiper gasket 190. As illustrated in FIG. 11, the wiper gasket 190 may be circular shaped to match the size and shape of the container 200. The wiper gasket 190 may be arranged in the base assembly 150 and the plunger 160 and specifically within the gasket channel 178. The wiper gasket 190 may engage the inner wall of the container 200. The wiper gasket 190 may prevent liquid and other contents below the plunger 160 from escaping around the plunger 160. The wiper gasket 190 may be seated in the gasket channel 178 formed in the plunger 160 and extending around a perimeter of the plunger 160.

In other examples, the wiper gasket 190 may be formed of a compressible elastomeric material, such as a silicone-based material, neoprene, nitrile, EPDM, or a rubber-based material. However, additional or alternative polymeric materials may be used, without departing from the scope of this disclosure. Various other gasket examples may be used with any of the containers described herein. In some examples, the wiper gasket 190 may be a traditional gasket having a substantially circular cross section. In other examples, the wiper gasket 190 may have a particular cross section configured to aid in venting the container. In some examples, the cross section may be a V-shaped or substantially V-shaped portion of the wiper gasket 190. The wiper gasket 190 may be a separate component or the wiper gasket 190 may be molded into the plunger 160 and/or the gasket channel 178.

As detailed above, the base assembly 150 may include a plunger 160 with a valve 180 symmetrically engaged with a top portion of the plunger 160. Further, the base assembly 150 may include a wiper gasket 190 that is located around the circumference of the plunger 160. The valve 180 may be attached to and engaged with the plunger 160 using a threaded portion 166 located in the center of the plunger 166. The second end 104 of the connect rod 102 may feed through a valve hole 182 in the center of the valve 180. The second end 104 and the second threaded portion 106 of the connect rod 102 may threadedly connect to and attach to the threaded portion 166 of the plunger 160. The lower flange 107 of the connect rod 102 may also hold and seat the valve 180 against the plunger 160, and specifically holding and seating against the upper rim 184 of the valve 180.

Turning now to the insulated container 200, as shown in FIGS. 12-15, the insulated container may be any insulated container 200 configured with the French press assembly 100. For example, the insulated container 200 may be any insulated container such as those described in U.S. patent application Ser. No. 18/166,523 filed on Feb. 9, 2023, which is fully incorporated by reference above.

As shown in FIGS. 12-15, the insulated container 200 can include an outer shell 230 having an external sidewall 230A and an outer bottom wall 230B. The insulated container 200 can also include an inner shell 232 having an inner sidewall 232A and an inner bottom wall 232B. The outer shell 230 can be connected to the inner shell 232 forming an insulated double wall structure with a sealed vacuum cavity between the outer shell 230 and the inner shell 232. The insulated container 200 can have a top opening 234 at a top of the inner sidewall 232A that leads into a storage cavity 240 formed by the inner sidewall 232A and the inner bottom wall 232B. The top opening 234 may also include a container pour spout 202. The insulated container 200 may include a handle 238 extending from the outer shell 230 and external sidewall 230A. While the illustrated example has a generally cylindrical shape, the shape of the container 200 may be any shape such as a rectangular cuboid, or other desired three-dimensional shape that could hold fluids, beverages, or other food items.

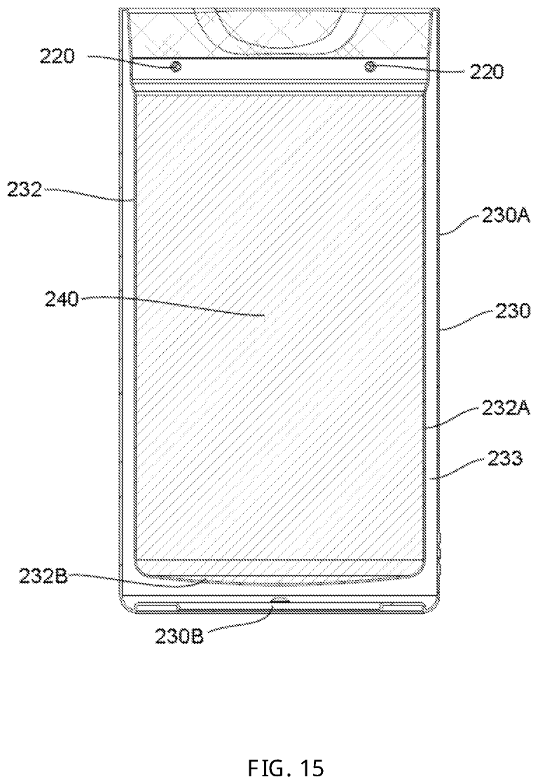

The insulated container 200 may include a container rim 212 configured to mate and engage with the rim 122 of the lid 120 and the French press assembly 100 when assembled to the container 200. In this example, the insulated container 200 may include a plurality of container projections 220 as shown in FIGS. 12 and 15 to engage with the lid 120 and the French press assembly 100. The number of the plurality of container projections 220 may be four in this example. The plurality of container projections 220 can be positioned radially about the container. As shown in FIGS. 12 and 15, the plurality of projections can be positioned on the inner side wall 232A of the insulated container 200. Additionally, the lid 120 may include various ridges and indentations 144 located along and around the circumference of the outside of the lid 120 to form a 360-degree gasket-less seal with the inner side wall 232A of the insulated container 200.

The French press assembly 100 and lid 120 may be configured to be placed onto the container 200 in a single orientation due to the plurality of insulated container projections 220. An engagement of the lid 120 of the French press assembly 100 with the insulated container 200 may create a force engaging the inner sidewall 232A of the insulated container 200, wherein the force is configured to retain the French press assembly 100 onto the insulated container 200.

In alternative configurations, it is also contemplated that the French press assembly 100 and the lid 120 can be secured to the insulated container assembly 200 using one or more of threads, bayonet connections, hinges, or collars and the like. In another example, a suction buttons or mechanism which pulls air from the contain or expands a gasket can be used to create a seal between the lid 120 of the French press assembly 100 and the insulated container 200. It is also contemplated that the lid 120 of the French press assembly 100 can be held onto the container assembly 200 using only the friction created between a gasket and the container assembly 200. The lid 120 of the French press assembly 100 may also include an outwardly extending tab, which extends from the rim 122, to provide the user with leverage in order to remove the French press assembly 100 from the insulated container 200.

The container assembly 200 may include a foot member to provide a slip resistant surface to support the container 200. Example foot members are described in U.S. application Ser. No. 17/868,471 filed on Jul. 19, 2022 and U.S. application Ser. No. 16/146,692, filed on Sep. 18, 2018, now U.S. Pat. No. 10,729,261, both of which are fully incorporated by reference herein. The foot member may be attached to the outer bottom wall 230B.

The insulated container 200 may include an opening, divot or dimple structure that may be used during a vacuum formation process. The opening, divot or dimple structure may be included anywhere on the outer shell 230 or the inner shell 232. Such dimple structures and formation processes are disclosed and described in U.S. application Ser. No. 16/146,692, filed on Sep. 18, 2018, now U.S. Pat. No. 10,729,261, U.S. Application No. 62/237,419, filed on Oct. 5, 2015, U.S. Application No. 62/255,886 filed on Nov. 16, 2015, and U.S. application Ser. No. 15/285,268, now U.S. Pat. No. 10,390,659, all of which are incorporated fully herein by reference. In one example, the divot or dimple can resemble a dome shape. However, other suitable shapes are contemplated for receiving a resin material during the manufacturing process. The example container assembly 200 can be provided with one or more vacuum chambers, such as internal cavity 233 shown in FIG. 15, to reduce heat transfer by conduction, convection and/or radiation. To achieve a vacuum between the outer body and inner body, the air within the container can be removed by heating the container within the vacuum and removing the air between the outer shell 230 and the inner shell 232 through the opening in the divot or dimple on outer shell 230 and/or inner shell 232.

Additional alternate methods of insulating the container 200 are also contemplated. For example, the internal cavity 233 may be filled with various insulating materials that exhibit low thermal conductivity such as foam. As such, the internal cavity 233 may, in certain examples, be filled with air to form air pockets for insulation, or filled with a mass of material such as a polymer material, or a polymer foam material. In one specific example, the internal cavity 233 may be filled with polystyrene. However, additional or alternative insulating materials may be utilized to fill the internal cavity 233 without departing from the scope of these disclosures. In certain examples, the internal cavity 233 is filled with insulating materials by injecting the materials via dimples, divots, or other conduits to the internal cavity 233. In other examples, the insulating materials are added to the internal cavity 233 prior to connecting the inner shell 232 with the outer shell 230. In other examples, the internal cavity 233 may be configured to be partially or wholly filled with an additional insulating material. For example, internal cavity 233 may be configured to be, or may be, at least partially filled with an alternative polymeric foam, such as polystyrene foam, polyvinyl chloride foam, or polyimide foam, among many others.

For the formation of the insulated container, the outer and inner shells 230, 232 may be formed as two separate pieces. The outer and inner shells 230, 232 may have a substantially constant wall thickness. The outer and inner shells 230, 232 may be constructed using one or more sheet-metal deep-drawing and/or stamping processes, and using, in one example, stainless steel sheet-metal. However, it will be readily appreciated that the insulated container 200 may be constructed using one or more additional or alternative metals and/or alloys, one or more fiber-reinforced materials, one or more polymers, or one or more ceramics, or combinations thereof, among others, without departing from the scope of these disclosures. Accordingly, one or both of the outer shell 230 and the inner shell 232 may have wall thicknesses (i.e. may utilize a sheet-metal thickness) ranging at or between 0.2 mm to 4 mm or approximately 0.5 mm, 1 mm, 1.5 mm, 2 mm, 2.5 mm, 3 mm, 4 mm, among others.

In one specific example, the inner shell 232 may be secured to the outer shell 230 by a welding operation utilizing a robotic arm and camera system in conjunction with a stationary electrode or the like to ensure that inner shell 230 is connected along the entire upper edges of the outer shell 230 and the inner shell 232. These coupling processes may integrally join the outer shell 230 and the inner shell 232 and may include one or more brazing or welding processes (including, among others, shielded metal arc, gas tungsten arc, gas metal arc, flux-cored arc, submerged arc, electroslag, ultrasonic, cold pressure, electromagnetic pulse, laser beam, or friction welding processes). In another example, the outer shell 230 may be integrally joined to the inner shell 232 by one or more adhesives, by a sheet metal hem joint, or by one or more fastener elements (e.g. one or more screws, rivets, pins, bolts, or staples, among others).

Once the shells 230, 232 are integrally joined, a mass of gas/air may be evacuated from the cavity formed between the inner and outer shells 230, 232 to create a sealed vacuum cavity 233 between the two shells 230, 232. To achieve a vacuum between the walls of the container 200 (e.g. between the outer sidewall 230 and the inner sidewall 232, and the outer bottom outer wall 230B and the inner bottom wall 232B), at least a portion of air between the two shells 230, 232 may be removed by positioning the container 200 within a larger chamber (not depicted), and removing at least a portion of the air from the cavity 233 between the shells 230, 232 by pulling a vacuum within the larger chamber (not depicted) (e.g. reducing an internal pressure of the larger chamber to a pressure below an internal pressure within the vacuum cavity 233). It will be appreciated that any techniques and/or processes may be utilized to reduce a pressure within the larger chamber (not depicted), including, vacuum pumping, among others. As such, a portion of air within the vacuum cavity 233 may escape through a dimple or divot located in a lower cavity on the outer bottom wall 230B. Again, it is also contemplated that several dimples, divots, or openings be placed on the outer bottom wall 230B. And in one example, the opening may be a round shaped hole.

In certain implementations, a pressure within the vacuum cavity 233 of the insulated container 200 may measure less than 15 μTorr. In other examples, the vacuum may measure less than 10 u Torr, less than 50 u Torr, less than 100 u Torr, less than 200 u Torr, less than 400 μTorr, less than 500 u Torr, less than 1000 μTorr, less than 10 mTorr, less than 100 mTorr, or less than 1 Torr, among many others.

In order to seal a vacuum within the vacuum cavity 233, a resin, which may be in the shape of a pill, may be placed into the dimple, divot, or opening during the vacuum forming process. In some examples, the vacuum formation chamber may be heated to a temperature at which the resin may become viscous. In one example, the viscosity of the resin may be such that the resin does not flow or drip into the container through the opening, but is permeable to air such that the air can escapes the internal volumes of the vacuum cavity 233. In one implementation, a vacuum forming process may heat the insulated container 200 to temperature of approximately 550° C. In other implementations, during the vacuum forming process the insulated container 200 may be heated to approximately 200° C. 250° C. 300° C., 350° C., 400° C., 450° C., 500° C., or 600° C., among others. Following a period of heating, the insulated container 200 may be passively or actively cooled to room temperature. As such, once the resin cools and solidifies, it covers the dimple, divot, or opening, and seals the internal volume of the container 200 to form a vacuum cavity 233 between the outer shell 230 and the inner shell 232.

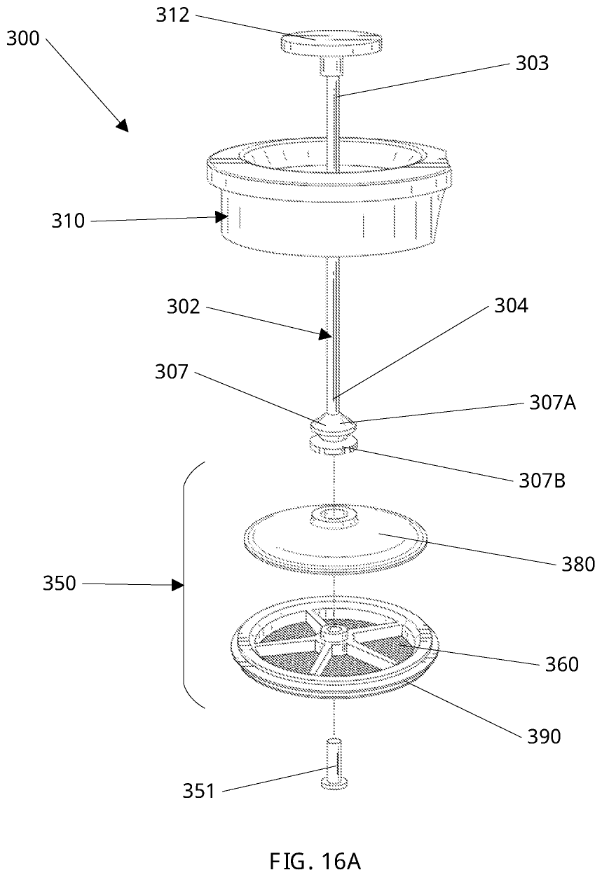

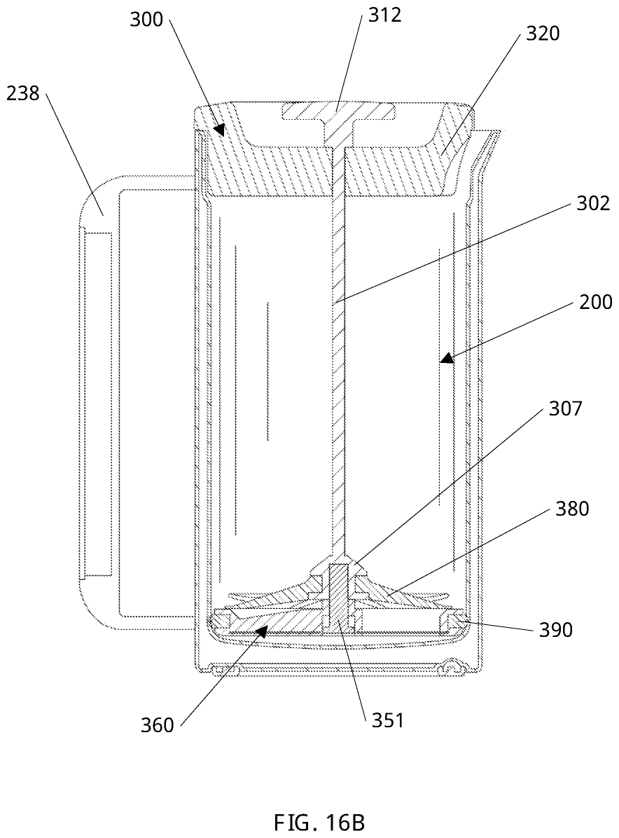

FIGS. 16A and 16B show another embodiment of a French press assembly 300 to be used with an insulated container 200. For the embodiment of FIGS. 16A and 16B, the features are referred to using similar reference numerals under the “3xx” series of reference numerals, rather than “1xx” as used in the embodiment of FIGS. 1A-11. A “3xx” feature may be similar to a “1xx,” feature. Accordingly, certain features of the French press assembly 300 and insulated container 200 that were already described above with respect to the French press assembly 100 of FIGS. 1A-11 and the insulated container 200 of FIGS. 12-15 may be described in lesser detail, or may not be described at all. Additionally, any features described above with respect to the French press assembly 100 of FIGS. 1A-11 and the insulated container 200 of FIGS. 12-15 may be utilized with the French press assembly 300 and insulated container 200. FIG. 16A illustrates an exploded component view of the French press assembly 300 and the insulated container 200. FIG. 16B illustrates a cross-sectional view of the container 200 with the French press assembly 300.

The French press assembly 300 may include a lid assembly 310 and a base assembly 350. As illustrated in FIG. 16B, the lid assembly 310 may include a double wall construction. The lid assembly 310 may or may not include a vacuum insulated construction. The lid assembly 310 and the base assembly 350 may be connected by a connect rod 302. The lid assembly 310 may include a handle 312 and a lid 320. The handle 312 may be connected to a first end 303 of the connect rod 302. The lid 320 may be slidably connected to the connect rod 302. The base assembly 350 may include a plunger 360 with a valve 380 and a wiper gasket 390. The plunger 360 and the base assembly 350 may be connected to a second end 304 of the connect rod 302 using a fastener 351. The fastener 351 may be inserted through the bottom side of the plunger 360 and thread into the second end 304 of the connect rod 302 to hold the plunger 360 and valve 380 together on the connect rod 302. The valve 380 may be located on a top side of the plunger 360. The valve 380 may seat within a fixing base 307 located on the second end 304 of the connect rod 302. The fixing base 307 may include an upper flange 307A and a lower flange 307B to hold the valve 380. The wiper gasket 390 may be located around a periphery of the plunger 360.

The handle 312, the lid 320, the connect rod 302, and/or the fastener 351 may formed and/or made of a stainless steel material. The handle 312, the lid 320, the connect rod 302, and/or the fastener 351 may also be titanium or other equivalent materials. The handle 312, the lid 320, the connect rod 302, and/or the fastener 351 may be formed, for example, of 18/8 kitchen-grade stainless steel or SUS 304. The handle 312, the lid 320, the connect rod 302, and/or the fastener 351 may be formed from food safe materials without departing from this disclosure. It is contemplated that various other materials could be used without departing from this disclosure.

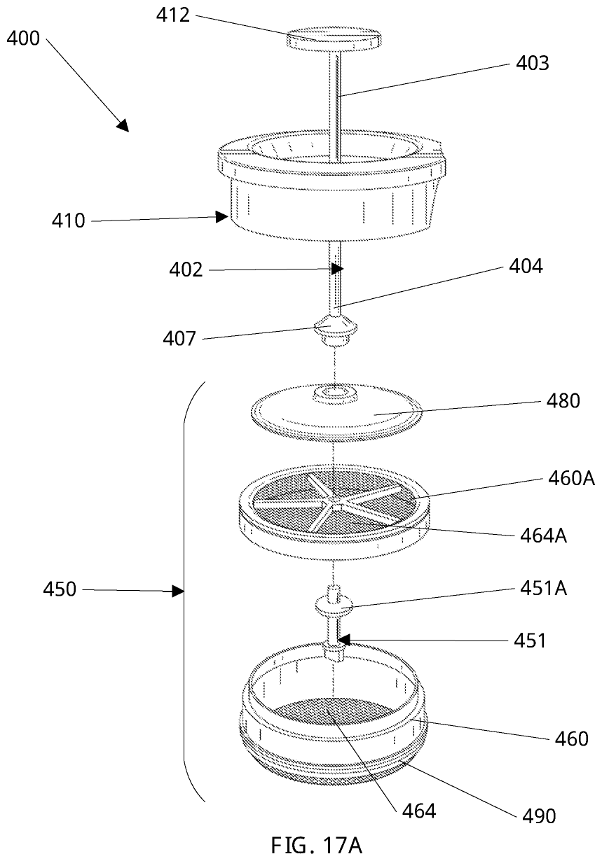

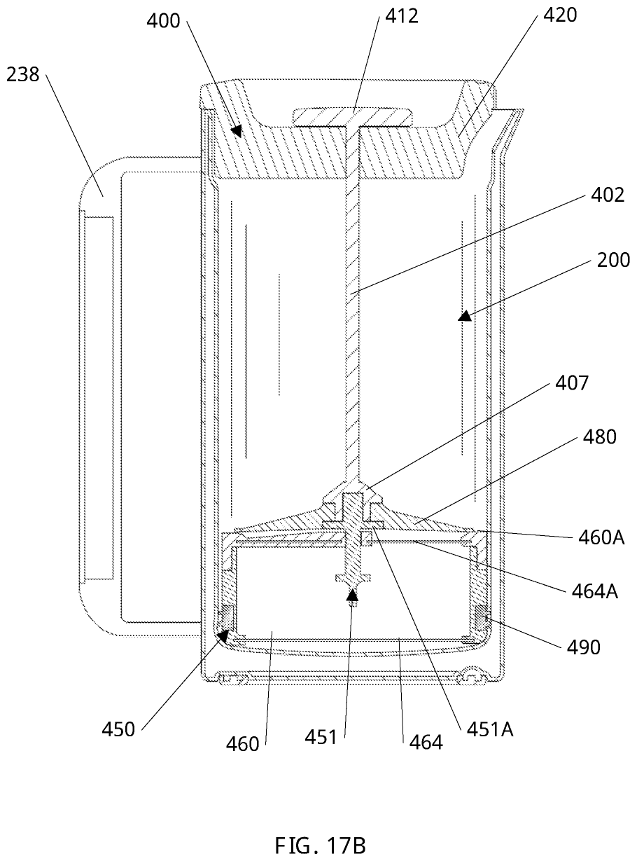

FIGS. 17A and 17B show another embodiment of a French press assembly 400 to be used with an insulated container 200. For the embodiment of FIGS. 17A and 17B, the features are referred to using similar reference numerals under the “4xx” series of reference numerals, rather than “1xx” as used in the embodiment of FIGS. 1A-11 and “3xx” as used in the embodiment of FIGS. 16A and 16B. A “4xx” feature may be similar to a “1xx” feature and/or a “3xx” feature. Accordingly, certain features of the French press assembly 400 and insulated container 200 that were already described above with respect to the French press assembly 100 of FIGS. 1A-11, the French press assembly 300 of FIGS. 16A-16B, and the insulated container 200 of FIGS. 12-15 may be described in lesser detail, or may not be described at all. Additionally, any features described above with respect to the French press assembly 100 of FIGS. 1A-11, the French press assembly 300 of FIGS. 16A-16B, and the insulated container 200 of FIGS. 12-15 may be utilized with the French press assembly 400 and insulated container 200. FIG. 17A illustrates an exploded component view of the French press assembly 400 and the insulated container 200. FIG. 17B illustrates a cross-sectional view of the container 200 with the French press assembly 400.

The French press assembly 400 may include a lid assembly 410 and a base assembly 450. The lid assembly 410 and the base assembly 450 may be connected by a connect rod 402. As illustrated in FIG. 17B, the lid assembly 410 may include a double wall construction. The lid assembly 410 may or may not include a vacuum insulated construction. The lid assembly 410 may include a handle 412 and a lid 420. The handle 412 may be connected to a first end 403 of the connect rod 402. The lid 420 may be slidably connected to the connect rod 402.

The base assembly 450 may include a filter base 460, a filter lid 460A, a valve 480, and a wiper gasket 490. The filter lid 460A may sit on the top of and cooperate with a top portion of the filter base 460. The filter base 460 may be in the form and shape of a basket to hold and contain the coffee grounds and or other materials within the filter base 460A. The filter base 460 may include a base filter 464 and the filter lid 460A may include a lid filter 464A. The base filter 464 and/or the lid filter 464A may be a stainless steel mesh filter. The base filter 464 and/or the lid filter 464A may also be titanium or other equivalent materials. The base filter 464 and/or the lid filter 464A may be formed, for example, of 18/8 kitchen-grade stainless steel or SUS 304. The base filter 464 and/or the lid filter 464A may be formed from food safe materials without departing from this disclosure. The base filter 464 and/or the lid filter 464A may include a filter or strainer size of 100 mesh.

The filter base 460 and/or the filter lid 460A may be formed or molded from a clear or transparent polymer material, such as Tritan™ or other food safe polymer. The filter base 460 and/or the filter lid 460A may be formed and made from other food safe materials without departing from this disclosure. The filter base 460 may include volume marks to help the user understand how much ground coffee or other materials to add into the container 200.

The filter base 460, the filter lid 460A, and the base assembly 450 may be connected to a second end 404 of the connect rod 402 using a fastener 451. The fastener 451 may be inserted through the bottom side of the filter base 460 and thread into the second end 404 of the connect rod 402 to hold the filter base 460, the filter lid 460A, and valve 480 together on the connect rod 402. The fastener 451 may include a flange 451A to hold the filter lid 460A on the filter base 460. The valve 480 may be located on a top side of the filter lid 460A. The valve 480 may be held against the filter lid 460A using a fixing base 407 or flange located on the second end 404 of the connect rod 402. The wiper gasket 490 may be located around a periphery of the filter base 460. In another embodiment, the wiper gasket 490 may be located around a periphery of the filter lid 460A.

The handle 412, the lid 420, the connect rod 402, and/or the fastener 451 may formed and/or made of a stainless steel material. The handle 412, the lid 420, the connect rod 402, and/or the fastener 451 may also be titanium or other equivalent materials. The handle 412, the lid 420, the connect rod 402, and/or the fastener 451 may be formed, for example, of 18/8 kitchen-grade stainless steel or SUS 304. The handle 412, the lid 420, the connect rod 402, and/or the fastener 451 may be formed from food safe materials without departing from this disclosure. It is contemplated that various other materials could be used without departing from this disclosure.

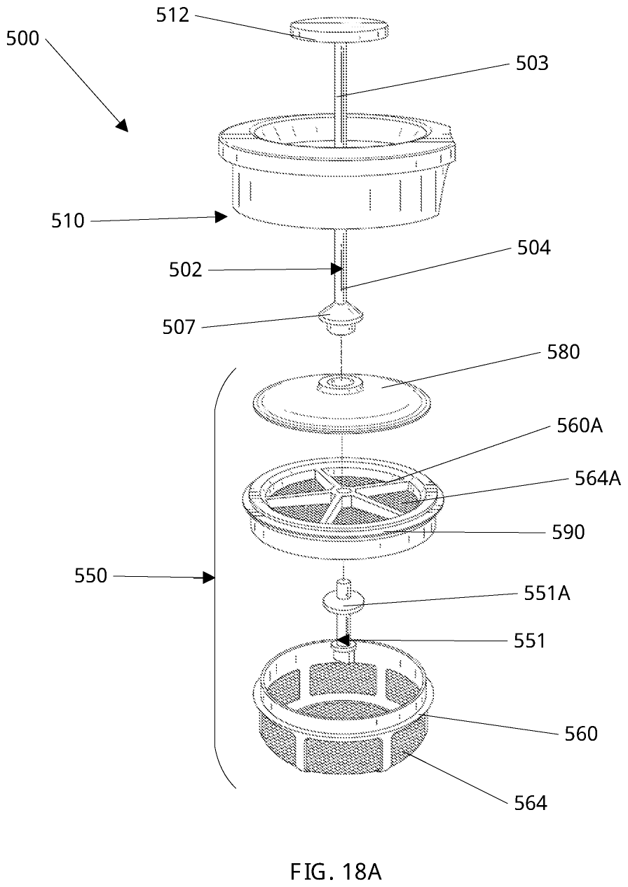

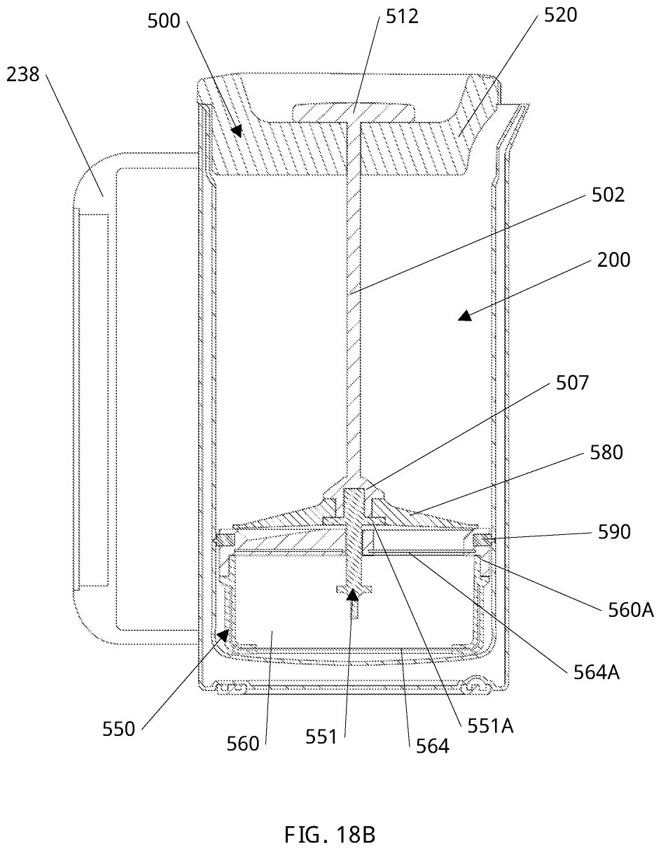

FIGS. 18A and 18B show another embodiment of a French press assembly 500 to be used with an insulated container 200. For the embodiment of FIGS. 18A and 18B, the features are referred to using similar reference numerals under the “5xx” series of reference numerals, rather than “1xx” as used in the embodiment of FIGS. 1A-11, “3xx” as used in the embodiment of FIGS. 16A and 16B, and “4xx” as used in the embodiment of 17A and 17B. A “5xx” feature may be similar to a “1xx” feature, a “3xx” feature, and/or a “4xx” feature. Accordingly, certain features of the French press assembly 500 and insulated container 200 that were already described above with respect to the French press assembly 100 of FIGS. 1A-11, the French press assembly 300 of FIGS. 16A-16B, the French press assembly 400 of FIGS. 17A-17B, and the insulated container 200 of FIGS. 12-15 may be described in lesser detail, or may not be described at all. Additionally, any features described above with respect to the French press assembly 100 of FIGS. 1A-11, the French press assembly 300 of FIGS. 16A-16B, the French press assembly 400 of FIGS. 17A-17B, and the insulated container 200 of FIGS. 12-15 may be utilized with the French press assembly 500 and insulated container 200. FIG. 18A illustrates an exploded component view of the French press assembly 500 and the insulated container 200. FIG. 18B illustrates a cross-sectional view of the container 200 with the French press assembly 500.

The French press assembly 500 may include a lid assembly 510 and a base assembly 550. The lid assembly 510 and the base assembly 550 may be connected by a connect rod 502. As illustrated in FIG. 18B, the lid assembly 510 may include a double wall construction. The lid assembly 510 may or may not include a vacuum insulated construction. The lid assembly 510 may include a handle 512 and a lid 520. The handle 512 may be connected to a first end 503 of the connect rod 502. The lid 520 may be slidably connected to the connect rod 502.

The base assembly 550 may include a filter base 560, a filter lid 560A, a valve 580, and a wiper gasket 590. The filter lid 560A may sit on the top of and cooperate with a top portion of the filter base 560. The filter base 560 may be in the form and shape of a basket to hold and contain the coffee grounds and or other materials within the filter base 560A. The filter base 560 may include a base filter 564 and the filter lid 560A may include a lid filter 564A. The base filter 564 and/or the lid filter 564A may be a stainless steel mesh filter. The base filter 564 and/or the lid filter 564A may also be titanium or other equivalent materials. The base filter 564 and/or the lid filter 564A may be formed, for example, of 18/8 kitchen-grade stainless steel or SUS 304. The base filter 564 and/or the lid filter 564A may be formed from food safe materials without departing from this disclosure. The base filter 564 and/or the lid filter 564A may include a filter or strainer size of 100 mesh. The filter base 660 and/or the filter lid 560A may be formed or molded from polypropylene material, or other food safe materials.

The filter base 560, the filter lid 560A, and the base assembly 550 may be connected to a second end 504 of the connect rod 502 using a fastener 551. The fastener 451 may be inserted through the bottom side of the filter base 560 and thread into the second end 504 of the connect rod 502 to hold the filter base 560, the filter lid 560A, and valve 580 together on the connect rod 502. The fastener 551 may include a flange 551A to hold the filter lid 560A on the filter base 560. The valve 580 may be located on a top side of the filter lid 560A. The valve 580 may be held against the filter lid 560A using a fixing base 507 or flange located on the second end 504 of the connect rod 502. The wiper gasket 590 may be located around a periphery of the filter base 560. In another embodiment, the wiper gasket 590 may be located around a periphery of the filter lid 560A.

The handle 512, the lid 520, the connect rod 502, and/or the fastener 551 may formed and/or made of a stainless steel material. The handle 512, the lid 520, the connect rod 502, and/or the fastener 551 may also be titanium or other equivalent materials. The handle 512, the lid 520, the connect rod 502, and/or the fastener 551 may be formed, for example, of 18/8 kitchen-grade stainless steel or SUS 304. The handle 512, the lid 520, the connect rod 502, and/or the fastener 551 may be formed from food safe materials without departing from this disclosure. It is contemplated that various other materials could be used without departing from this disclosure.

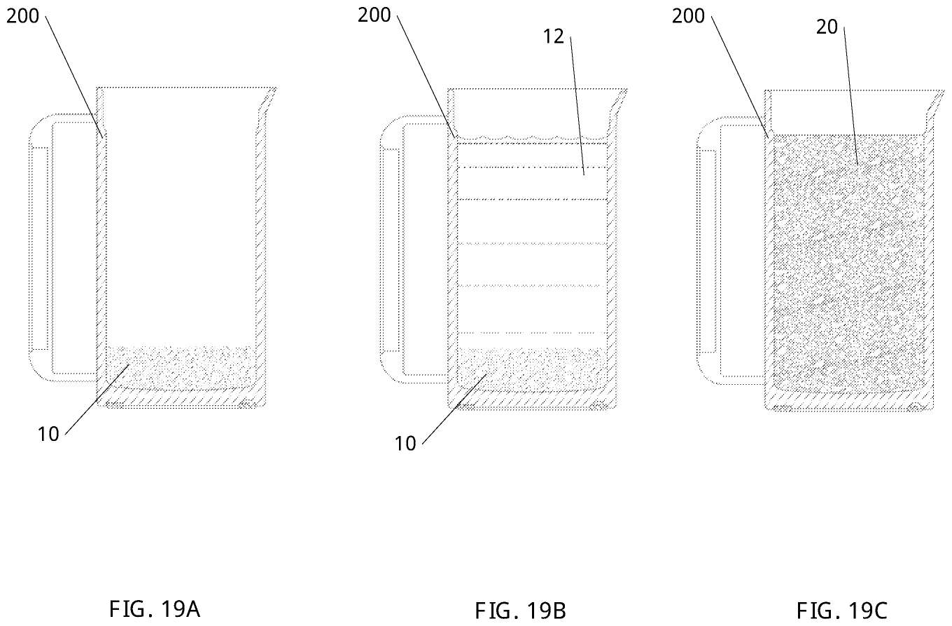

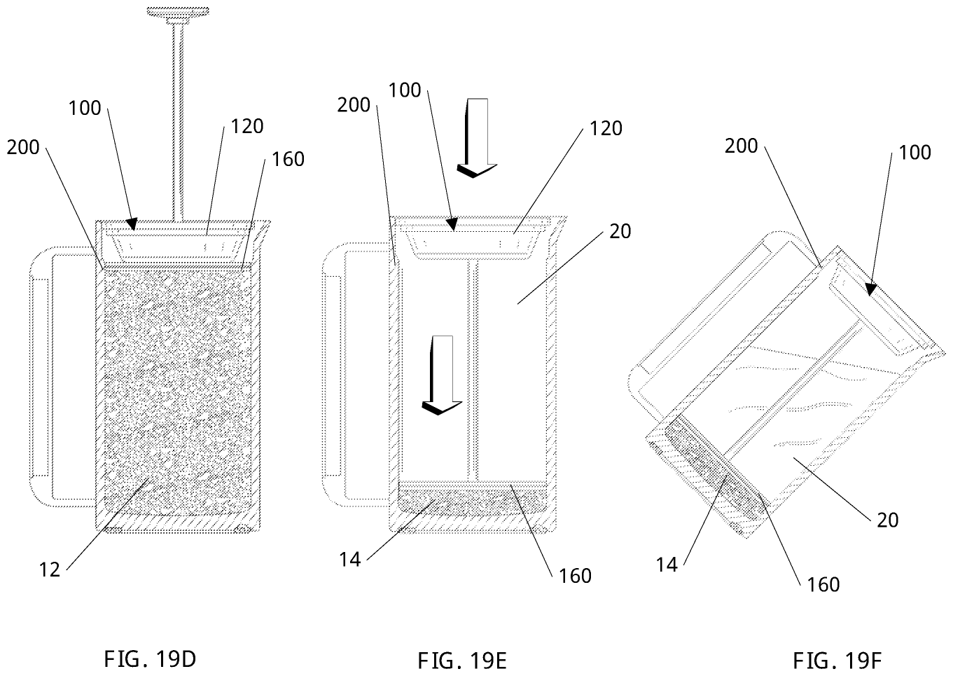

FIGS. 19A-19F illustrate an exemplary embodiment of a method for utilizing the French press assembly 100, 300, 400, 500 and container 200 as described and detailed above, such as a method for making coffee, making tea, or making another beverage, etc. For purposes of clarity, the method is only illustrated using French press assembly 100, however it will be understood that similar steps may be repeated using French press assembly 300, 400, 500.

FIGS. 19A-19F illustrate various steps of utilizing the French press assembly 100, 300, 400, 500 and container 200. FIG. 19A illustrates adding the coffee/beverage grounds 10 to the container 200. FIG. 19B illustrates adding the water/liquid 12 to the container 200. FIG. 19C illustrates mixing and stirring the coffee/beverage grounds 10 with water/liquid 12 in the container 200 to start to create the brewed coffee/beverage 20. The stirring may utilize a spoon or other stirring utensil. FIG. 19D illustrates the extraction phase. The extraction phase may be defined as placing the French press assembly 100 and lid 120 on top of container 200 with the plunger 160 extended upward (without pressing the plunger 160 downward) and waiting the appropriate extraction time. FIG. 19E illustrates plunging the plunger 160 and filter 164 downward all the way to the bottom of the container 200. During this phase, the valve 180 separates brewed coffee/beverage 20 from plunged grounds 14 which prevents over-extraction of the coffee/beverage 20. FIG. 19F illustrates pouring and serving the brewed coffee/beverage 20 from container 200. As illustrated in FIG. 19F, the plunger 160, valve 180, and gasket 190 maintain the plunged ground 14 at the bottom of the container 200 while the brewed coffee/beverage 20 is poured from the container 200.

The French press assembly 100, 300, 400, 500 as disclosed may be utilized with the container and/or any other container for brewing coffee. Also, it is contemplated that the French press assembly 100, 300, 400, 500 as disclosed could be used for various other functions without departing from this disclosure, such as: making/brewing tea, brewing cold brew coffee, frothing milk, making whipped cream, rinsing grains, draining defrosted foods, mixing drinks/cocktails, infusing oils, rehydrating dried food items, or infusing water with herbs or fruit.

Aspects of the disclosure include a French press assembly comprising: a lid assembly configured to mate with a top portion of a container and a base assembly connected to the lid assembly with the connect rod. The lid assembly may comprise: a lid slidably connected to a connect rod and a handle connected to a first end of the connect rod. The base assembly may comprise a plunger, a valve symmetrically engaged with a top portion of the plunger, and a gasket located around a periphery and circumference of the plunger. The plunger may include a plunger body, a filter extending from an outer rim of the plunger body to an inner rim of the plunger body, and a threaded portion located within a cavity within the inner rim of the plunger body. The threaded portion may be connected to a second end of the connect rod.

The lid of the French press assembly may include a rim, a recessed surface adjacent to the rim, and a base surface adjacent to the recessed surface. The rim and the base surface of the lid may be on a same plane and are parallel to each other. The recessed surface may extend at an angle from the rim to the base surface. The base surface and the lid may include a hole located at a radial center of the base surface, wherein the hole receives and passes through the connect rod. The base surface may include a vent portion extending around the hole along the radial center of the base surface. The vent portion may prevent glugging when pouring a beverage from the container. The vent portion may include one or more horizontal channels located on a top portion of the vent portion and/or one or more vertical channels located within the hole of the lid. In one example, the vent portion may include three horizontal channels and three vertical channels located equidistant around the top surface of the of the vent portion and within the hole of the lid. In another example, the vent portion may include two horizontal channels and two vertical channels located equidistant around the top surface of the of the vent portion and within the hole of the lid. The lid may be formed or molded from a clear or transparent polymer material, such as Tritan™ or other food safe polymer.

Additionally, the connect rod may include a lower flange located at the second end of the connect rod. The first end of the connect rod may include a first threaded portion to threadedly connect to and attach to the handle. The second end of the connect rod may include a second threaded portion to threadedly connect to and attach to the base assembly and the plunger. The connect rod can be formed of a stainless steel or titanium, for example, or other equivalent material. The connect rod may be formed, for example, of 18/8 kitchen-grade stainless steel or SUS 304.

The plunger body may include one or more spokes that extend from the inner rim to the outer rim. The plunger body may include a plurality of spokes, wherein each of the plurality of spokes are located equidistant around the plunger body. The filter may be held by the one or more spokes. The filter may be a stainless steel filter with a mesh size of 100 mesh. The inner rim may include a spacer that extends from a top surface of the inner rim. The spacer may mate with a bottom portion of the valve. The plunger body may include a U-shaped channel sized and shaped to fit the gasket. The gasket may be formed of a compressible elastomeric material, such as a silicone-based material, neoprene, nitrile, EPDM, or a rubber-based material.

The valve may include a valve body with a valve hole located in a radial center of the valve body, wherein the valve hole receives and passes through the connect rod. The valve body may include an upper valve rim located around the valve hole on a top side of the valve body and a lower valve rim located around the valve hold on a bottom side of the valve body. The upper valve rim may engage with a lower flange located on the connect rod. The lower valve rim may engage with a spacer located on the plunger. The valve may be formed of silicone, for example, or other equivalent material to deform and form around the plunger and mesh filter.

Aspects of the disclosure may also include an insulated container comprising: an outer shell comprising an external sidewall and an outer bottom wall and an inner shell comprising an inner sidewall and an inner bottom wall. The outer shell connected to the inner shell may form an insulated double wall structure with a sealed vacuum cavity between the outer shell and the inner shell. The insulated container may have a top opening at a top of the inner sidewall that leads into a storage cavity formed by the inner sidewall and the inner bottom wall. The top opening may comprise a container pour spout.

The present disclosure is disclosed above and in the accompanying drawings with reference to a variety of examples. The purpose served by the disclosure, however, is to provide examples of the various features and concepts related to the disclosure, not to limit the scope of the disclosure. One skilled in the relevant art will recognize that numerous variations and modifications may be made to the examples described above without departing from the scope of the present disclosure.

What is claimed is:

1. A French press assembly configured to be secured to a container, the French press assembly comprising:
a lid assembly configured to mate with a top portion of a container, the lid assembly comprising:
a lid slidably connected to a connect rod, wherein the lid includes a vent portion extending around a hole on a radial center of the lid, wherein the vent portion prevents glugging when pouring a beverage from the container; and
a handle connected to a first end of the connect rod; and
a base assembly connected to the lid assembly with the connect rod, the base assembly comprising:
a plunger that includes a plunger body, a filter extending from an outer rim of the plunger body to an inner rim of the plunger body, and a threaded portion located within a cavity within the inner rim of the plunger body, the threaded portion connected to a second end of the connect rod;
a valve symmetrically engaged with a top portion of the plunger; and
a gasket located around a periphery and circumference of the plunger.

2. The French press assembly of claim 1, wherein the lid includes a rim, a recessed surface adjacent to the rim, and a base surface adjacent to the recessed surface and the recessed surface extends at an angle from the rim to the base surface.

3. The French press assembly of claim 2, wherein the rim and the base surface of the lid are on a same plane and are parallel to each other.

4. The French press assembly of claim 1, wherein the vent portion includes one or more horizontal channels located on a top surface of the vent portion and one or more vertical channels located within the hole of the lid.

5. The French press assembly of claim 1, wherein the first end of the connect rod includes a first threaded portion to threadedly connect to and attach to the handle and the second end of the connect rod includes a lower flange and a second threaded portion to threadedly connect to and attach to the base assembly and the plunger.

6. The French press assembly of claim 1, wherein the plunger body includes one or more spokes that extend from the inner rim to the outer rim and the one or more spokes hold the filter.

7. The French press assembly of claim 1, wherein the valve includes a valve body with a valve hole located in a radial center of the valve body, wherein the valve hole receives and passes through the connect rod, wherein the valve body includes an upper valve rim located around the valve hole on a top side of the valve body and a lower valve rim located around the valve hold on a bottom side of the valve body, wherein the upper valve rim engages with a lower flange located on the connect rod and the lower valve rim engages with a spacer located on the plunger.

8. The French press assembly of claim 1, wherein an outer circumference of the valve deforms upward during a plunging of the plunger.

9. A French press assembly configured to be secured to a container, the French press assembly comprising:
a lid assembly configured to mate with a top portion of a container, the lid assembly comprising:
a lid slidably connected to a connect rod, wherein the lid comprises:
a rim,
a recessed surface adjacent to the rim,
a base surface adjacent to the recessed surface, wherein the rim and the base surface of the lid are on a same plane and are parallel to each other, the recessed surface extends at an angle from the rim to the base surface, and the base surface includes a hole located at a radial center of the base surface, wherein the hole receives and passes through the connect rod, and
a vent portion extending around the hole of the base surface, wherein the vent portion is a slot-shaped vent that prevents glugging when pouring a beverage from the container; and
a handle connected to a first end of the connect rod; and
a base assembly connected to the lid assembly with the connect rod, the base assembly comprising:
a plunger that includes a plunger body, a filter extending from an outer rim of the plunger body to an inner rim of the plunger body, and a threaded portion located within a cavity within the inner rim of the plunger body, the threaded portion connected to a second end of the connect rod, wherein the plunger body includes one or more spokes that extend from the inner rim to the outer rim, wherein the filter is held by the one or more spokes within the plunger body;
a valve symmetrically engaged with a top portion of the plunger; and
a gasket located around a periphery and circumference of the plunger, wherein the plunger body includes a U-shaped channel sized and shaped to fit the gasket.

10. The French press assembly of claim 9, wherein the base surface includes a vent portion extending around the hole along the radial center of the base surface, wherein the vent portion is a slot-shaped vent that prevents glugging when pouring a beverage from the container.

11. The French press assembly of claim 10, wherein the vent portion includes one or more horizontal channels located on a top portion of the vent portion.

12. The French press assembly of claim 10, wherein the vent portion includes one or more vertical channels located within the hole of the lid.

13. The French press assembly of claim 9, wherein the first end of the connect rod includes a first threaded portion to threadedly connect to and attach to the handle and the second end of the connect rod includes a lower flange and a second threaded portion to threadedly connect to and attach to the base assembly and the plunger.

14. The French press assembly of claim 9, wherein the plunger body includes a plurality of spokes, wherein each of the plurality of spokes are located equidistant around the plunger body.

15. The French press assembly of claim 9, wherein the valve includes a valve body with a valve hole located in a radial center of the valve body, wherein the valve hole receives and passes through the connect rod, wherein the valve body includes an upper valve rim located around the valve hole on a top side of the valve body and a lower valve rim located around the valve hold on a bottom side of the valve body, wherein the upper valve rim engages with a lower flange located on the connect rod and the lower valve rim engages with a spacer located on the plunger.

16. A French press container assembly comprising:
an insulated container comprising:
an outer shell comprising an external sidewall and an outer bottom wall, and
an inner shell comprising an inner sidewall and an inner bottom wall,
the outer shell connected to the inner shell forming an insulated double wall structure with a sealed vacuum cavity between the outer shell and the inner shell,
the insulated container having a top opening at a top of the inner sidewall that leads into a storage cavity formed by the inner sidewall and the inner bottom wall, the top opening comprising a container pour spout; and
a French press assembly configured to be secured to the insulated container, the French press assembly comprising:
a lid assembly configured to mate with a top portion of a container, the lid assembly comprising:
a lid slidably connected to a connect rod, wherein the lid includes a vent portion extending around a hole on a radial center of the lid, wherein the vent portion prevents glugging when pouring a beverage from the container; and
a handle connected to a first end of the connect rod; and
a base assembly connected to the lid assembly with the connect rod, the base assembly comprising:
a plunger that includes a plunger body, a filter extending from an outer rim of the plunger body to an inner rim of the plunger body, and a threaded portion located within a cavity within the inner rim of the plunger body, the threaded portion connected to a second end of the connect rod;
a valve symmetrically engaged with a top portion of the plunger; and
a gasket located around a periphery and circumference of the plunger.

17. The French press container assembly of claim 16, wherein the lid includes a rim, a recessed surface adjacent to the rim, and a base surface adjacent to the recessed surface and the recessed surface extends at an angle from the rim to the base surface.

18. The French press container assembly of claim 16, wherein the first end of the connect rod includes a first threaded portion to threadedly connect to and attach to the handle and the second end of the connect rod includes a lower flange and a second threaded portion to threadedly connect to and attach to the base assembly and the plunger.

19. The French press container assembly of claim 16, wherein the plunger body includes one or more spokes that extend from the inner rim to the outer rim and the one or more spokes hold the filter.

20. The French press container assembly of claim 16, wherein the valve includes a valve body with a valve hole located in a radial center of the valve body, wherein the valve hole receives and passes through the connect rod, wherein the valve body includes an upper valve rim located around the valve hole on a top side of the valve body and a lower valve rim located around the valve hold on a bottom side of the valve body, wherein the upper valve rim engages with a lower flange located on the connect rod and the lower valve rim engages with a spacer located on the plunger.
